(19) United States
(12) Patent Application Publication
(10) Pub. No.: US 2024/0186031 A1
(43) Pub. Date: Jun. 6, 2024

(54) FLUOROPOLYMER COMPOSITIONS COMPRISING AMORPHOUS FLUOROPOLYMER AND CRYSTALLINE FLUOROPOLYMER SUITABLE FOR COPPER AND ELECTRONIC TELECOMMUNICATIONS ARTICLES

(71) Applicant: 3M INNOVATIVE PROPERTIES COMPANY, St. Paul, MN (US)

(72) Inventors: Naiyong Jing, St. Paul, MN (US); Klaus Hintzer, Kastl, MN (US); Xiaoming Kou, Woodbury, MN (US); Cheng Li, Shanghai (CN); Zai-Ming Qiu, Woodbury, MN (US); Siwei Leng, Woodbury, MN (US); Leon M. Lillie, St. Paul, MN (US); Michael C. Dadalas, Burghausen (DE); Steffen Vowinkel, Burghausen (DE); Timothy A. Mertens, West Lakeland, MN (US); Tatsuo Fukushi, Woodbury, MN (US); Maria C. Lindsay, Minneapolis, MN (US)

(21) Appl. No.: 18/552,261

(22) PCT Filed: Apr. 7, 2022
(86) PCT No.: PCT/IB2022/053284

§ 371 Date: Sep. 25, 2023

Related U.S. Application Data
(60) Provisional application No. 63/184,392, filed on May 5, 2021.

(51) Int. Cl. H01B 3/44; C08F 214/18; C08F 214/26; C08K 3/36; C09D 127/18

(52) U.S. Cl. CPC H01B 3/445; C08F 214/184; C08F 214/26; C08K 3/36; C09D 127/18

(57) ABSTRACT

Electronic telecommunication articles are described comprising a layer of fluoropolymer composition comprising: an amorphous fluoropolymer comprising at least 80, 85, or 90% by weight of polymerized units perfluorinated monomers including one or more unsaturated perfluorinated alkyl ethers; and crystalline fluoropolymer; wherein the fluoropolymer composition lacks crosslinks of a chemical curing agent. Also described are methods of making a coated substrate, substrates comprising a fluoropolymer composition, and fluoropolymer compositions.

### SUMMARY

In one embodiment, an electronic telecommunication article is described comprising a layer of fluoropolymer composition comprising: an amorphous fluoropolymer comprising at least 80, 85, or 90% by weight of polymerized units perfluorinated monomers including one or more unsaturated perfluorinated alkyl ethers; and crystalline fluoropolymer; wherein the fluoropolymer composition lacks crosslinks of a chemical curing agent.

In another embodiment, a method of making a coated substrate is described comprising providing a fluoropolymer composition comprising: an amorphous fluoropolymer comprising at least 80, 85, or 90% by weight of polymerized units of perfluorinated monomers including one or more unsaturated perfluorinated alkyl ethers; and crystalline fluoropolymer; and applying the fluoropolymer composition to a substate.

Also described is a substrate comprising a fluoropolymer composition comprising: an amorphous fluoropolymer comprising at least 80, 85, or 90% by weight of polymerized units perfluorinated monomers including one or more unsaturated perfluorinated alkyl ethers; and crystalline fluoropolymer; wherein the fluoropolymer composition lacks crosslinks of a chemical curing agent.

Fluoropolymer compositions are also described.

### BRIEF DESCRIPTION OF THE DRAWINGS

FIG. 1 is a schematic cross-sectional diagram of a patterned fluoropolymer layer;

FIG. 2 is a perspective view of an illustrative printed circuit board (PCB) including integrated circuits;

FIGS. 3A and 3B are cross-sectional diagrams of illustrative fluoropolymer passivation and insulating layers;

FIG. 4 is a plan view of an illustrative antenna of a mobile computer device;

FIGS. 5A and 5B are perspective views of illustrative antennas of a telecommunications tower;

FIG. 6 is a cross-sections diagram of an illustrative optical fiber cable;

FIGS. 7-10 are rheology curves of an illustrative fluoropolymer composition, PFE-3/CFP-2 (7:3), in comparison to the same composition with various concentrations of chemical curing agent.

### DETAILED DESCRIPTION

### Electronic Telecommunication Articles

Presently described are certain fluoropolymer compositions (e.g. films and coatings) for use in electronic telecommunication articles. As used herein, electronic refers to devices using the electromagnetic spectrum (e.g. electrons, photons); whereas telecommunication is the transmission of signs, signals, messages, words, writings, images and sounds or information of any nature by wire, radio, optical or other electromagnetic systems.

Polyimide materials are used extensively in the electronic telecommunications industry. The structure of poly-oxydiphenylene-pyromellitimide, “Kapton” is as follows:

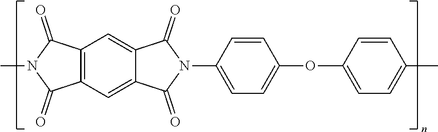

Polyimide films exhibited good insulating properties with dielectric constants values in the range of 2.78-3.48 and dielectric loss between 0.01 and 0.03 at 1 Hz at room temperature.

Perfluoropolymers can have substantially lower dielectric constants and dielectric loss properties than polyimides which is particularly important for fifth generation cellular network technology (“5G”) articles. For example, fluoropolymer compositions described herein can have a dielectric constant (Dk) of less than 2.75, 2.70, 2.65, 2.60, 2.55, 2.50, 2.45, 2.40, 2.35, 2.30, 2.25, 2.20, 2.15, 2.10, 2.05, 2.00, or 1.95. In some embodiments, the dielectric constant is at least 2.02, 2.03, 2.04, 2.05. Further, the fluoropolymer compositions described herein can have a low dielectric loss, typically less than 0.01, 0.009, 0.008, 0.007, 0.006, 0.005, 0.004, 0.003, 0.002, 0.001, 0.0009, 0.0008, 0.0007, 0.0006, 0.0005, 0.0004, 0.0003. In some embodiments, the dielectric loss is at least 0.00022, 0.00023, 0.00024, 0.00025. The dielectric properties (e.g. constant and loss) can be determined according to the test method described in the examples. As the number of non-fluorine atoms increases (e.g. number of carbon-hydrogen and/or carbon-oxygen bonds increases) the dielectric constant and dielectric loss also typically increases.

However, perfluoropolymers have not been used in place of polyimides is various electronic telecommunications articles are least in part by the lack of perfluoropolymer materials that can be bond to certain substrates such as copper, especially at lower temperatures. Hence, the perfluoropolymer compositions described are suitable for use in place of polyimides in various electronic telecommunication articles.

In one embodiment, the electronic telecommunication article is an integrated circuit or in other words a silicon chip or microchip, i.e. a microscopic electronic circuit array formed by the fabrication of various electrical and electronic components (resistors, capacitors, transistors, and so on) on a semiconductor material (silicon) wafer. Various integrated circuit designs have been described in the literature.

In some embodiments, particularly when it is desirable to apply a thin fluoropolymer film to the substrate, the method comprises applying a coating solution (e.g. spin coating) to a substrate. The coating solution comprises a fluorinated solvent and a fluoropolymer. The method typically comprises removing the fluorinated solvent (e.g. by evaporation). In this embodiment, the substrate or (e.g. SiO₂) coated surface thereof that comes in contact with the solvent is substantially insoluble in the fluorinated solvent of the coating solution. Further, the method typically comprises recycling, or in other words reusing, the fluorinated solvent of the coating solution.

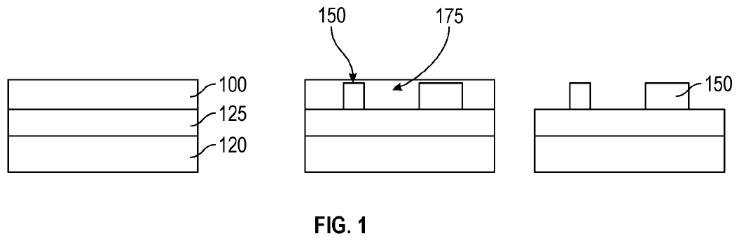

In some embodiments, the fluoropolymer layer may be characterized are a patterned fluoropolymer layer. A patterned fluoropolymer may be formed by any suitable additive or subtractive method known in the art. With reference to FIG. 1, in one embodiment, a method of forming a patterned fluoropolymer layer is described comprising applying a fluoropolymer film 100 to a substrate (e.g. silicon wafer 120, the passivation (e.g. SiO₂) layer 125 coated surface thereof or copper); and selectively removing portions of the fluoropolymer film. For example, portions 175 of the fluoropolymer layer may be removed with methods, such as laser ablation. Fluoropolymer portions 150 remain, thereby forming a patterned fluoropolymer layer.

The patterned fluoropolymer layer can be used to fabricate other layers such as a circuit of patterned electrode materials. Suitable electrode materials and deposition methods are known in the art. Such electrode materials include, for example, inorganic or organic materials, or composites of the two. Exemplary electrode materials include polyaniline, polypyrrole, poly(3,4-ethylenedioxythiophene) (PEDOT) or doped conjugated polymers, further dispersions or pastes of graphite or particles of metal such as Au, Ag, Cu, Al, Ni or their mixtures as well as sputter-coated or evaporated metals such as Cu, Cr, Pt/Pd, Ag, Au, Mg, Ca, Li or mixtures or metal oxides such as indium tin oxide (ITO), F-doped ITO, GZO (gallium doped zinc oxide), or AZO (aluminium doped zinc oxide). Organometallic precursors may also be used and deposited from a liquid phase.

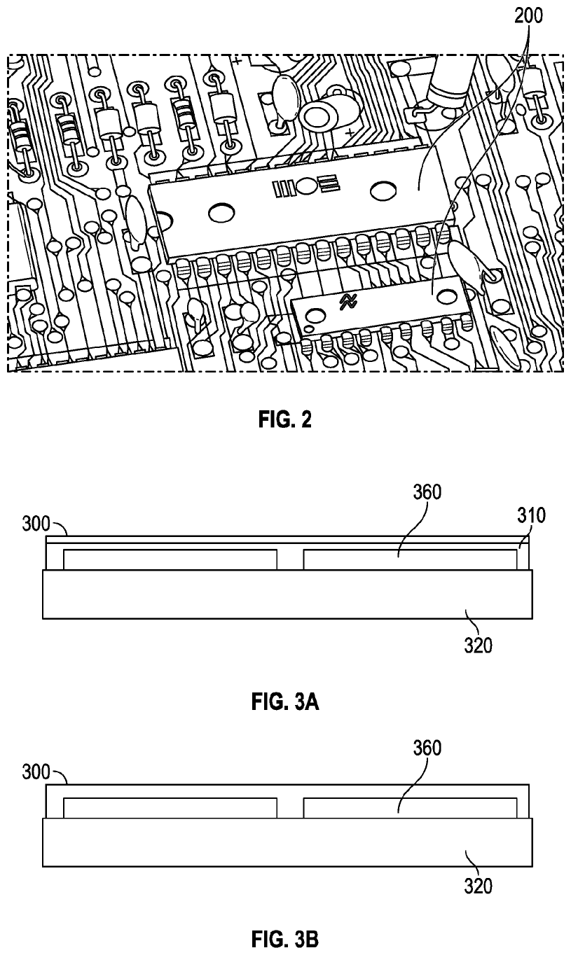

In another embodiment, a (e.g. patterned) fluoropolymer layer can be disposed upon a metal (e.g. copper) substrate in the manufacture of a printed circuit board (PCB). An illustrative perspective view of a printed circuit board is depicted in FIG. 2. A printed circuit board, or PCB, is used to mechanically support and electrically connect electronic components using conductive pathways, tracks or signal traces etched from (e.g. copper) metal sheets laminated onto a non-conductive substrate. Such boards are typically made from an insulating material such as glass fiber reinforced (fiberglass) epoxy resin or paper reinforced phenolic resin. The pathways for electricity are typically made by forming a patterned fluoropolymer layer on the surface of the (e.g. copper) metal substrate, as previously described. In some embodiments, portions of fluoropolymer are removed to form the conductive (e.g. copper) pathways. Fluoropolymer remains present, disposed between the conductive (e.g. copper) pathways of the printed circuit board. Solder is used to mount components on the surface of these boards. In some embodiments, the printed circuit board further comprises integrated circuits 200, as depicted in FIG. 2. Printed circuit board assemblies have an application in almost every electronic article including computers, computer printers, televisions, and cell phones.

In another embodiment, a fluoropolymer layer or in other word fluoropolymer film as described herein can be utilized as an insulating layer, passivation layer, and/or protective layer in the manufacture of integrated circuits.

With reference to FIG. 3A, in one embodiment, a thin fluoropolymer film 300 (e.g. typically having a thickness less than 50, 40, or 30 nm) can be disposed on a passivation layer 310 (e.g. SiO₂) disposed on an electrode patterned 360 silicon chip 320.

With reference to FIG. 3B, in another embodiment, a thicker fluoropolymer film 300 (e.g. typically having a thickness of at least 100, 200, 300, 400, 500 nm) can be disposed on an electrode patterned 360 silicon chip 320. In this embodiment, the fluoropolymer layer may function as both a passivation layer and an insulating layer. Passivation is the use of a thin coating to provide electrical stability by isolating the transistor surface from electrical and chemical conditions of the environment.

In another embodiment, the fluoropolymer film described herein can be utilized as a substrate for antennas. The antenna of the transmitter emits (e.g. high frequency) energy into space while the antenna of the receiver catches this and converts it into electricity.

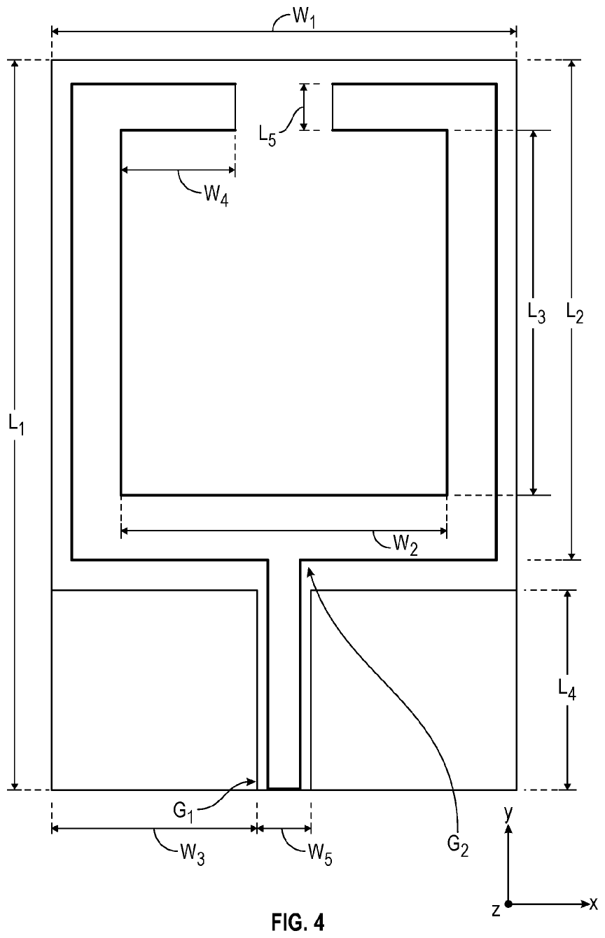

The patterned electrodes of an antenna can also be formed from photolithography. Screen printing, flexography, and ink jet printing can also be utilized to form the electrode pattern as known in the art. Various antenna designs for (e.g. mobile) computing devices (smart phone, tablet, laptop, desktop) have been described in the literature. One representative split ring monopole antenna is depicted in FIG. 4 having the following dimensions in microns.

| | | | |
|---|---|---|---|
| L₁ | 38 | W₁ | 25 |
| L₂ | 26 | W₂ | 18 |
| L₃ | 19 | W₃ | 10.5 |
| L₄ | 9.5 | W₄ | 6.5 |
| L₅ | 3 | W₅ | 2 |
| G₁ | 2 | G₂ | 0.5 |

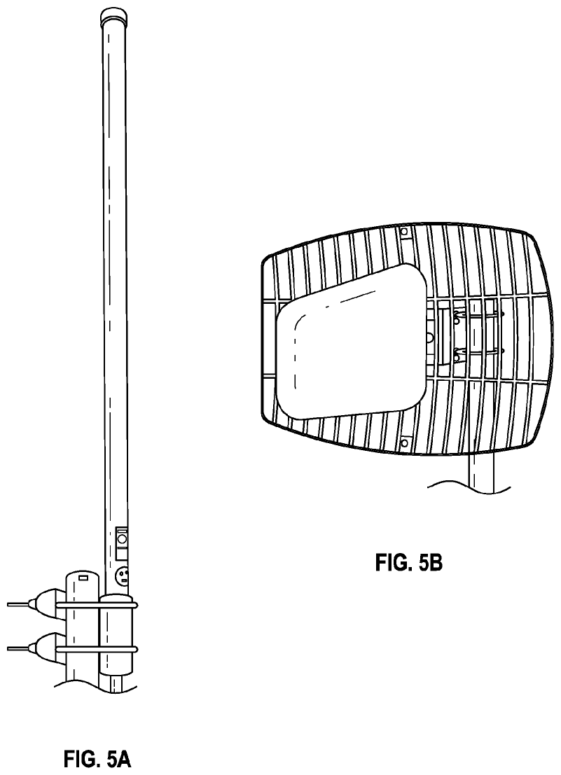

The low dielectric fluoropolymer films and coatings described herein can also be utilized as insulating and protective layers of transmitter antennas of cell towers and other (e.g. outdoor) structures. There are two major types of antennas used in cell towers. FIG. 5A is depicts a representative omnidirectional (e.g. dipole) antenna used to transmit/receive in any direction. FIG. 5B is a representative directional antenna used to transmit/receive in particular desired direction only such as horn antennas of circular and rectangular type.

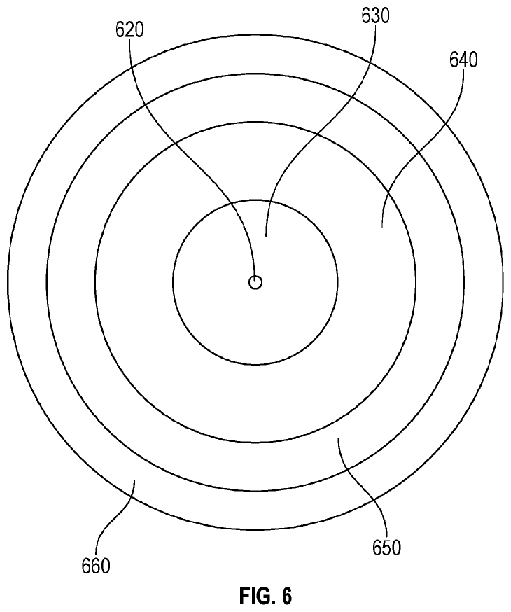

In another embodiment, the low dielectric fluoropolymer compositions described herein may also be utilized in fiber optic cable. With reference to FIG. 6, fiber optic cable typically includes five main components: the core which is typically highly pure (e.g. silica) glass 620, cladding 630, coating (e.g. first inner protective layer) 640, strengthening fibers 650, and outer jacket (i.e. second outer protective layer) 660. The function of the cladding is to provide a lower refractive index at the core interface in order to cause reflection within the core so that light waves are transmitted through the fiber. The coating over the cladding is typically present to reinforce the fiber core, help absorb shocks, and provide extra protection against excessive cable bends. The low dielectric fluoropolymer compositions described herein can be used as the cladding, coating, outer jacket, or combination thereof.

In other embodiments, the low dielectric fluoropolymer films and coatings described herein can also be utilized for flexible cables and as an insulating film on magnet wire. For example, in a laptop computer, the cable that connects the main logic board to the display (which must flex every time the laptop is opened or closed) may be a low dielectric fluoropolymer composition as described herein with copper conductors.

The electronic telecommunication article is typically not a sealing component of equipment used in wafer and chip production.

One of ordinary skill in the art appreciates that the low dielectric fluoropolymer compositions described herein can be utilized in various electronic telecommunication articles, particularly in place of polyimide, and such utility is not limited to the specific articles described herein.

### Fluoropolymers

The fluoropolymers described herein are copolymers that comprise predominantly, or exclusively, (e.g. repeating) polymerized units derived from two or more perfluorinated comonomers. Copolymer refers to a polymeric material resulting from the simultaneous polymerization of two or more monomers. The comonomers include tetrafluoroethene (TFE), one or more unsaturated perfluorinated (e.g. alkenyl, vinyl) alkyl ethers.

In some favored embodiments, the one or more unsaturated perfluorinated alkyl ethers are selected from the general formula:

R_{f}—O—(CF₂)ₙ—CF═CF₂

wherein n is 1 (allyl ether) or 0 (vinyl ether) and R_{f} represents a perfluoroalkyl residue which may be interrupted once or more than once by an oxygen atom. R_{f} may contain up to 10 carbon atoms, e.g. 1, 2, 3, 4, 5, 6, 7, 8, 9 or 10 carbon atoms. Preferably R_{f} contains up to 8, more preferably up to 6 carbon atoms and most preferably 3 or 4 carbon atoms. In one embodiment R_{f} has 3 carbon atoms. In another embodiment R_{f} has 1 carbon atom. R_{f} may be linear or branched, and it may contain or not contain a cyclic unit. Specific examples of R_{f} include residues with one or more ether functions including but not limited to:
—(CF₂)—O—C₃F₇,
—(CF₂)₂—O—C₂F₅,
—(CF₂)ᵣ₃—O—CF₃,
—(CF₂—O)—C₃F₇,
—(CF₂—O)₂—C₂F₅,
—(CF₂—O)₃—CF₃,
—(CF₂CF₂—O)—C₃F₇,
—(CF₂CF₂—O)₂—C₂F₅,
—(CF₂CF₂—O)₃—CF₃,

Other specific examples for R_{f} include residues that do not contain an ether function and include but are not limited to —C₄F₉; —C₃F₇, —C₂F₅, —CF₃, wherein the C₄ and C₃ residues may be branched or linear, but preferably are linear.

The unsaturated perfluorinated alkyl either may comprise allyl or vinyl groups. Both have C—C double bonds. Whereas a perfluorinated vinyl group is CF₂═CF—; a perfluorinated allyl group is CF₂═CFCF₂—.

Specific examples of suitable perfluorinated alkyl vinyl ethers (PAVE's) and perfluorinated alkyl allyl ethers (PAAE's) include but are not limited to perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, CF₂═CF—O—CF₂—O—C₂F₅, CF₂═CF—O—CF₂—O—C₃F₇, CF₃—(CF₂)₂—O—CF(CF₃)—CF₂—O—CF(CF₃)—CF₂—O—CF═CF₂ and their allyl ether homologues. Specific examples of allyl ethers include CF₂═CF—CF₂—O—CF₃, CF₂═CF—CF₂—O—C₃F₇, CF₂═CF—CF₂—O—(CF₃)₃—O—CF₃. Further examples include but are not limited to the vinyl ether described in European Patent EP 1,997,795.

In some embodiments, the (e.g. amorphous) fluoropolymer comprises polymerized units of at least one allyl ether, such as alkyl vinyl ether is CF₂═CFCF₂OCF₂CF₂CF₃. Such fluoropolymers are described in WO 2019/161153, incorporated herein by reference.

Perfluorinated alkyl ethers as described above are commercially available, for example from Anles Ltd., St. Petersburg, Russia and other companies or may be prepared according to methods described in U.S. Pat. No. 4,349,650 (Krespan) or European Patent 1,997,795, or by modifications thereof as known to a skilled person.

In some embodiments, the one or more unsaturated perfluorinated alkyl ethers comprises unsaturated cyclic perfluorinated alkyl ethers, such as 2,2-bistrifluoromethyl-4,5-difluoro-1,3 dioxole. Amorphous fluoropolymer that comprise predominantly, or exclusively comprise, (e.g. repeating) polymerized units derived from two or more perfluorinated comonomers including tetrafluoroethene (TFE) and one or more unsaturated cyclic perfluorinated alkyl ethers, such as 2,2-bistrifluoromethyl-4,5-difluoro-1,3 dioxole are commercially available as “TEFLON™ AF”, “CYTOP™”, and “HYFLON™”.

In some favored embodiments, the fluoropolymers are derived predominantly or exclusively from perfluorinated comonomers including tetrafluoroethene (TFE) and one or more of the unsaturated perfluorinated alkyl ethers described above. “Predominantly” as used herein means at least 80, 85, or 90% by weight based on the total weight of the fluoropolymer, of the polymerized units of the fluoropolymer are derived from such perfluorinated comonomers such as tetrafluoroethene (TFE) and one or more unsaturated perfluorinated alkyl ethers. In some embodiments, the fluoropolymer comprises at least 81, 82, 83, 84, 85, 86, 87, 88, 90, 91, 92, 93, 94, 95, 96, or 97% by weight or greater of such perfluorinated comonomers, based on the total weight of the fluoropolymer. The fluoropolymers may contain at least 40, 45, or 50% by weight of polymerized units derived from TFE. In some embodiments, the maximum amount of polymerized units derived from TFE is no greater than 60% or 55% by weight.

The fluoropolymer typically comprises polymerized units derived from one or more of the unsaturated perfluorinated alkyl ethers (PAVE) (e.g. PMVE, PAAE or a combination thereof), in an amount of at least 10, 15, 20, 25, 30, 45, or 50% by weight, based on the total polymerized monomer units of the fluoropolymer. In some embodiments, the fluoropolymer comprises no greater than 50, 45, 40, or 35% by weight of polymerized units derived from one or more of the unsaturated perfluorinated alkyl ethers (PMVE, PAAE or a combination thereof), based on the total polymerized monomer units of the fluoropolymer. The molar ratio of units derived from TFE to the perfluorinated alkyl ethers described above may be, for example, from 1:1 to 5:1. In some embodiments, the molar ratio ranges from 1.5:1 to 3:1.

Fluoropolymers comprising a sufficient amount of polymerized units of one or more of the unsaturated perfluorinated alkyl ethers are typically amorphous fluoropolymers. As used herein, amorphous fluoropolymers are materials that contain essentially no crystallinity or possess no significant melting point (peak maximum) as determined by differential scanning calorimetry in accordance with DIN EN ISO 11357-3:2013-04 under nitrogen flow and a heating rate of 10° C./min. Typically, amorphous fluoropolymers have a glass transition temperature (Tg) of less than 26° C., less than 20° C., or less than 0° C., and for example from −40° C. to 20° C., or −50° C. to 15° C., or −55° C. to 10° C. The fluoropolymers may typically have a Mooney viscosity (ML 1+10 at 121° C.) of from about 2 to about 150, for example from 10 to 100, or from 20 to 70. For amorphous polymers containing cyclic perfluorinated alky ether units, the glass transition temperature is typically at least 70° C., 80° C., or 90° C., and may range up to 220° C., 250° C., 270° C., or 290° C. The MFI (297° C./5 kg) is between 0.1-1000 g/10 min.

The fluorine content of the fluoropolymer is typically at least 60, 65, 66, 67, 68, 69, or 70 wt. % of the fluoropolymer and typically no greater than 76, 75, 74, or 73 wt. %. The fluorine content may be achieved by selecting the comonomers and their amounts accordingly.

Such highly-fluorinated amorphous fluoropolymers typically do not dissolve to the extent of at least 1 wt. %, at room temperature and standard pressure, in a hydrogen-containing organic liquid (e.g., it does not dissolve in any of methyl ethyl ketone (“MEK”), tetrahydrofuran (“THF”), ethyl acetate or N-methyl pyrrolidinone (“NMP”)).

The (e.g. amorphous and crystalline) fluoropolymers can be prepared by methods known in the art, such as bulk, suspension, solution or aqueous emulsion polymerization. (See for example EP 1,155,055; U.S. Pat. No. 5,463,021; WO 2015/088784 and WO 2015/134435) Various emulsifiers can be used as described in the art, including for example 3H4-perfluoro-3[(3-methoxy-propoxy)propanoic acid. For example, the polymerization process can be carried out by free radical polymerization of the monomers alone or as solutions, emulsions, or dispersions in an organic solvent or water. Seeded polymerizations may or may not be used. Curable fluoroelastomers that can be used also include commercially available fluoroelastomers, in particular perfluoroelastomers.

The fluoropolymers may have a monomodal or bi-modal or multi-modal weight distribution. The fluoropolymers may or may not have a core-shell structure. Core-shell polymers are polymers where towards the end of the polymerization, typically after at least 50% by mole of the comonomers are consumed, the comonomer composition or the ratio of the comonomers or the reaction speed is altered to create a shell of different composition.

The fluoropolymers may contain partially fluorinated or non-fluorinated comonomers and combinations thereof, although this is not preferred. Typical partially fluorinated comonomers include but are not limited to 1,1-difluoroethene (vinylidenefluoride, VDF) and vinyl fluoride (VF) or trifluorochloroethene or trichlorofluoroethene. Examples of non-fluorinated comonomers include but are not limited to ethene and propene. In typical embodiments, the fluoropolymer composition comprises no greater than 8, 7, 6, 5, 4, 3, 2, 1 or 0.1 wt.-% of polymerized units derived from non-fluorinated or partially fluorinated monomers based on the total weight of the fluoropolymer.

### Optional Cure Sites & Modifying Monomers

The fluoropolymer composition of the fluoropolymer layer lacks crosslinks of a chemical curing agent. Thus, the fluoropolymer compositions described herein lacks chemical curing agents and/or the fluoropolymer(s) thereof lack cure sites that reacts with such chemical curing agent. It is appreciated that a chemical curing agent in the absence of a fluoropolymer with cure sites does not result in crosslinks of a chemical curing agent. It is also appreciated that a fluoropolymer with cure sites in the absence of a chemical curing agent does not result in crosslinks of a chemical curing agent. Thus, the fluoropolymer(s) may optionally contain one or more cure sites in the absence of a chemical curing agent. Alternatively, the fluoropolymer composition may optionally contain chemical curing agent in the absence of fluoropolymer with cure sites.

In typical embodiments, the fluropolymer composion lacks chemical curing agents, described in WO 2021/091864, incorporated herein by reference. Thus, the fluoropolymer lacks chemical curing agents such as a peroxides, amines, ethylenically unsaturated compounds; and amino organosilane ester compounds or ester equivalent. The fluoropolymer composition also lacks one or more compounds comprising an electron donor group (such as an amine) in combination with an ethylenically unsaturated group.

In typical embodiments, the fluoropolymer(s) of the fluoropolymer composition also lacks cure sites such as nitrile, iodine, bromine, and chlorine. However, fluoropolymers comprising such cure sites are commercially available. Thus, some of the exemplified composition comprise such cure sites, even though such cure sites are not reacted with a chemical curing agent to chemically crosslink the fluoropolymers. Further, the inclusion of cure sites, such as nitrile, can improve adhesion of the fluoropolymer composition to a substrate.

Cure sites are functional groups that react in the presence of a curing agent or a curing system to cross-link the polymers. The cure sites are typically introduced by copolymerizing cure-site monomers, which are functional comonomers already containing the cure sites or precursors thereof. One indication of crosslinking is that the dried and cured coating composition was not soluble in the fluorinated solvent of the coating. The cure sites may be introduced into the polymer by using cure site monomers, i.e. functional monomers, functional chain-transfer agents and starter molecules as further described in WO 2021/091864. The fluoroelastomers may contain cure sites that are reactive to more than one class of curing agents.

The fluoroelastomers contain cure sites in the backbone, as pendent groups, or cure sites at a terminal position. Cure sites within the fluoropolymer backbone can be introduced by using a suitable cure-site monomer. Cure site monomers are monomers containing one or more functional groups that can act as cure sites or contain a precursor that can be converted into a cure site.

In some embodiments, the fluoropolymer comprises halogen cure sites, i.e. cure sites comprising iodine, bromine or chlorine. When present, the amount of iodine or bromine or chlorine or their combination in the fluoropolymer is between 0.001 and 5%, preferably between 0.01 and 2.5%, or 0.1 to 1% or 0.2 to 0.6% by weight with respect to the total weight of the fluoropolymer. In one embodiment the curable fluoropolymers contain between 0.001 and 5%, preferably between 0.01 and 2.5%, or 0.1 to 1%, more preferably between 0.2 to 0.6% by weight of iodine based on the total weight of the fluoropolymer.

In some embodiments, the fluoropolymer contains nitrile-containing cure sites as well as corresponding amidines, amidine salts, imidate, amides and ammonium salts. Fluoropolymers with nitrile-containing cure sites are known, such as described in U.S. Pat. Nos. 6,720,360 and 7,019,082. When present, the amount of nitrile-containing cure site comonomer is typically at least 0.5, 1, 1.5, 2, 2.5, 3, 3.5, 4, 4.5 or 5% by weight and typically no greater than 10% by weight; based on the total weight of the fluoropolymer.

The fluoropolymers may or may not contain units derived from at least one modifying monomer. The modifying monomers may introduce branching sites into the polymer architecture. Typically, the modifying monomers are bisolefins, bisolefinic ethers or polyethers. The bisolefins and bisolefinic (poly)ethers may be perfluorinated, partially fluorinated or non-fluorinated. Preferably they are perfluorinated. Suitable perfluorinated bisolefinic ethers include those represented by the general formula:

CF₂═CF—(CF₂)ₙ—O—(Rf)—O—(CF₂)ₘ—CF═CF₂

wherein n and m are independent from each other either 1 or 0 and wherein Rf represents a perfluorinated linear or branched, cyclic or acyclic aliphatic or aromatic hydrocarbon residue that may be interrupted by one or more oxygen atoms and comprising up to 30 carbon atoms. A particular suitable perfluorinated bisolefinic ether is a di-vinylether represented by the formula:

CF₂═CF—O—(CF₂)ₙ—O—CF═CF₂

wherein n is an integer between 1 and 10, preferably 2 to 6., e.g. n may be 1, 2, 3, 4, 5, 6 or 7. More preferably, n represents an uneven integer, for example 1, 3, 5 or 7.

Further specific examples include bisolefinic ethers according the general formula

CF₂═CF—(CF₂)ₙ—O—(CF₂)ₚ—O—(CF₂)ₘ—CF═CF₂

wherein n and m are independently either 1 or 0 and p is an integer from 1 to 10 or 2 to 6. For example, n may be selected to represent 1, 2, 3, 4, 5, 6 or 7, preferably, 1, 3, 5 or 7.

Further suitable perfluorinated bisolefinic ethers can be represented by the formula

CF₂═CF—(CF₂)ₚ—O—(R_{af}O)ₙ(R_{bf}O)ₘ—(CF₂)_{g}—CF═CF₂

wherein R_{af} and R_{bf} are different linear or branched perfluoroalkylene groups of 1-10 carbon atoms, in particular, 2 to 6 carbon atoms, and which may or may not be interrupted by one or more oxygen atoms. R_{af} and/or R_{bf} may also be perfluorinated phenyl or substituted phenyl groups; n is an integer between 1 and 10 and m is an integer between 0 and 10, preferably m is 0. Further, p and q are independently 1 or 0.

In another embodiment, the perfluorinated bisolefinic ethers can be represented by the formula just described wherein m, n, and p are zero and q is 1-4.

Modifying monomers can be prepared by methods known in the art and are commercially available, for example, from Anles Ltd., St. Petersburg, Russia.

Preferably, (e.g. ethylenically unsaturated) modifying monomers are not used or only used in low amounts. Typical amounts include from 0 to 5%, or from 0 to 1.4% by weight based on the total weight of the fluoropolymer. Modifiers may be present, for example, in amounts from about 0.1% to about 1.2% or from about 0.3% to about 0.8% by weight based on the total weight of fluoropolymer. Combinations of modifiers may also be used. Further, in typical embodiments, the fluoropolymer composition comprises no greater than 8, 7, 6, 5, 4, 3, 2, 1 or 0.1 wt.-% of polymerized units with (e.g. (meth)acrylate) ester-containing moieties.

### Crystalline Fluoropolymer

The fluoropolymer composition of the fluoropolymer layer further comprises crystalline fluoropolymer. The crystalline fluoropolymer may be present as particles. Alternatively, the crystalline fluoropolymer may be present as a second phase that may be formed by sintering the crystalline fluoropolymer particles at a temperature at or above the melting temperature of the crystalline fluoropolymer particles or melting and extruding the fluoropolymer composition.

In some embodiments, the fluoropolymer particles may be characterized as an “agglomerate” (e.g. of latex particles), meaning a weak association between primary particles such as particles held together by charge or polarity. Agglomerates are typically physically broken down into smaller entities such as primary particles during preparation of the coating solution. In other embodiments, the fluoropolymer particles may be characterized as an “aggregate”, meaning strongly bonded or fused particles, such as covalently bonded particles or thermally bonded particles prepared by processes such as sintering, electric arc, flame hydrolysis, or plasma. Aggregates are typically not broken down into smaller entities such as primary particles during preparation of the coating solution. “Primary particle size” refers to the mean diameter of a single (non-aggregate, non-agglomerate) particle.

In one embodiment, the fluoropolymer composition is prepared by blending a latex containing (e.g. crystalline) fluoropolymer particles with a latex containing amorphous fluoropolymer particles.

The latexes can be combined by any suitable manner such as by vortex mixing for 1-2 minutes. The method further comprises coagulating the mixture of latex particles. Coagulation may be carried out, for example, by chilling (e.g., freezing) the blended latexes or by adding a suitable salt (e.g., magnesium chloride) or inorganic acid. Chilling is especially desirable for coatings that will be used in semiconductor manufacturing and other applications where the introduction of salts may be undesirable. The method further comprising optionally washing the coagulated mixture of amorphous fluoropolymer particles and crystalline fluoropolymer particles. The washing step may substantially remove emulsifiers or other surfactants from the mixture and can assist in obtaining a well-mixed blend of substantially unagglomerated dry particles. In some embodiments, the surfactant level of the resulting dry particle mixture may, for example, be less than 0.1% by weight, less than 0.05% by weight or less than 0.01% by weight. The method further comprises drying the coagulated latex mixture. The coagulated latex mixture can be dried by any suitable means such as air drying or oven drying. In one embodiment, the coagulated latex mixture can be dried at 100° C. for 1-2 hours.

In some embodiments, the dried coagulated latex mixture can be dissolved in a fluorinated solvent suitable for dissolving the amorphous fluoropolymer particles to form a stable coating composition containing a homogeneous dispersion of the crystalline fluoropolymer particles in a solution of the amorphous fluoropolymer. In other embodiments, the dried coagulated latex mixture can be thermally processed.

The coating solution can be utilized to provide a coating on a substrate by applying a layer of the coating composition to a surface of a substrates and drying (i.e. removing the fluorinated solvent by evaporation) the coating composition. In some embodiments, the method further comprises heating the coated substrate to a temperature above the melt temperature of the fluoropolymer particles to sinter the fluoropolymer particles.

In some embodiments, the method further comprises rubbing (e.g. buffing, polishing) the dried layer thereby forming an amorphous fluoropolymer binder layer containing (e.g. crystalline) micron and optionally submicron fluoropolymer particles. A variety of rubbing techniques can be employed at the time of coating formation or later when the coated article is used or about to be used. Simply wiping or buffing the coating a few times using a cheesecloth or other suitable woven, nonwoven or knit fabric will often suffice to form the desired thin layer. Those skilled in the art will appreciate that many other rubbing techniques may be employed. Rubbing can also reduce haze in the cured coating.

The crystalline fluoropolymer particles at the coating surface forms a thin, continuous or nearly continuous fluoropolymer surface layer disposed on the underlying coating comprised of the amorphous fluoropolymer. In preferred embodiments the thin crystalline fluoropolymer layer is relatively uniformly smeared over the underlying coating and appears to be thinner and more uniform than might be the case if the fluoropolymer particles had merely undergone fibrillation (e.g., due to orientation or other stretching).

Average roughness (Ra) of the surface is the arithmetic average of the absolute values of the surface height deviation measured from the mean plane. The fluoropolymer layer or fluoropolymer film has a low average roughness. In some embodiments, Ra is at least 40 or 50 nm, ranging up to 100 nm before rubbing. In some embodiments, the surface after rubbing is at least 10, 20, 30, 40, 50 or 60% smoother. In some embodiments, Ra is less than 35, 30, 25, or 20 nm after rubbing.

When a thin coating is prepared from micron sized fluoropolymer particles the average roughness can be greater. In some embodiments, the average roughness is micron sized. However, when the thickness of the coating or fluoropolymer film is greater than the particle size of the (e.g. crystalline) fluoropolymer particles, the surface of the fluoropolymer coating or film can have a low average roughness as previously described.

An advantage of the coating compositions described herein is that the coating compositions can be used to prepare coatings of high or low thickness. In some embodiments, the dried and cured coating has a thickness of 0.1 microns to 10 mils. In some embodiments, the dried and cured coating thickness is at least 0.2, 0.3, 0.4, 0.5, or 0.6 microns. In some embodiments, the dried and cured coating thickness is at least 1, 2, 3, 4, 5, 6, 7, 8, 9, or 10 microns ranging up to 100, 150, or 200 microns.

A variety of crystalline fluoropolymer particles may be employed including mixtures of different crystalline fluoropolymer (e.g. particles). The crystalline fluoropolymer particles typically have high crystallinity and therefore a significant melting point (peak maximum) as determined by differential scanning calorimetry in accordance with DIN EN ISO 11357-3:2013-04 under nitrogen flow and a heating rate of 10° C./min. Thus, the crystalline fluoropolymer (e.g. particles) are typically thermoplastic.

For example, the crystalline fluoropolymer (e.g. particles) may include fluoropolymers having a Tm of at least 100, 110, 120, or 130° C. In some embodiments, the crystalline fluoropolymer (e.g. particles) may include fluoropolymers having a Tm no greater than 350, 340, 330, 320, 310 or 300° C.

The crystalline fluoropolymer (e.g. particles) typically have a fluorine content greater than about 50 weight percent. Also, the fluoropolymer (e.g. particles) may include fluoropolymers having a fluorine content between about 50 and about 76 weight percent, between about 60 and about 76 weight percent, or between about 65 and about 76 weight percent.

Representative crystalline fluoropolymers include, for example, perfluorinated fluoropolymers such as 3™ Dyneon™ PTFE Dispersions TF 5032Z, TF 5033Z, TF 5035Z, TF 5050Z, TF 5135GZ, and TF 5070GZ; and 3M™ Dyneon™ Fluorothermoplastic Dispersions PFA 6900GZ, PFA 6910GZ, FEP 6300GZ, THV 221, THV 340Z, and THV 800. Other suitable fluoropolymer (e.g. particles) are available from suppliers such as Asahi Glass, Solvay Solexis, and Daikin Industries and will be familiar to those skilled in the art.

Commercial aqueous dispersion usually contain non-ionic and/or ionic surfactants at concentration up to 5 to 10 wt. %. These surfactants are substantially removed by washing the coagulated blends. A residual surfactant concentration of less than 1, 0.05, or 0.01 wt. % may be present. Quite often it is more convenient to use the “as polymerized” aqueous fluoropolymer-latexes as they do not contain such higher contents of non-ionic/ionic surfactants.

As previously described, the crystalline fluoropolymers have a melt point that can be determined by DSC. Crystallinity depends on the selection and concentration of polymerized monomers of the fluoropolymer. For example, PTFE homopolymers (containing 100% TFE-units) have a melting point (Tm) above 340° C. The addition of comonomers, such as the unsaturated (per)fluorinated alkyl ethers, reduces the Tm. For example, when the fluoropolymer contains about 3-5 wt. % of polymerized units of such comonomer, the Tm is about 310° C. As yet another example, when the fluoropolymer contains about 15-20 wt. % of polymerized units of HFP, the Tm is about 260-270° C. As yet another example, when the fluoropolymer contains 30 wt. % of polymerized units of (per)fluorinated alkyl ethers (e.g. PMVE) or other comonomer(s) that reduce the crystallinity the fluoropolymer no longer has a detectable melting point via DSC, and thus is characterized as being amorphous.

In some embodiments, the crystalline fluoropolymer (e.g. particles) contain at least 40, 45, 50, 55, 60, 65, 70, 75, 80, 85, 90, 95 or about 100 wt. % of polymerized units of TFE. The crystalline fluoropolymer typically has a greater amount of polymerized units of TFE than the first amorphous fluoropolymer. More typically the crystalline fluoropolymer (e.g. particles) contain at least 70, 75, 85, 90, 95 or about 100 wt. % of polymerized units of TFE. Further, the crystalline fluoropolymer (e.g. particles) typically comprise a lower concentration of unsaturated (per)fluorinated alkyl ethers (e.g. PMVE) than the amorphous flurorpolymer. In typical embodiments, the crystalline fluoropolymer (e.g. particles) contain less than 30, 29, 28, 27, 26, 25, 24, 23, 22, 21, 20, 19, 18, 17, 16, 15, 14, 13, 12, 11, 10, 9, 8, 7, 6, or 5 wt. % of polymerized units of (per)fluorinated alkyl ethers.

In some embodiments, the crystalline fluoropolymers are copolymers formed from the constituent monomers known as tetrafluoroethylene (“TFE”), hexafluoropropylene (“HFP”), and vinylidene fluoride (“VDF,” “VF2,”). The monomer structures for these constituents are shown below:

TFE:CF₂═CF₂ (1)

VDF:CH₂═CF₂ (2)

HFP:CF₂═CF—CF₃ (3)

In some embodiments, the crystalline fluoropolymer consists of at least two of the constituent monomers (HFP and VDF), and in some embodiments all three of the constituents monomers in varying amounts.

The Tm depends on the amounts of TFE, HFP, and VDF. For example, a fluoropolymer comprising about 45 wt. % of polymerized units of TFE, about 18 wt. % of polymerized units of HFP, and about 37 wt. % of polymerized units of VDF has a Tm of about 120° C. As yet another example, a fluoropolymer comprising about 76 wt. % of polymerized units of TFE, about 11 wt. % of polymerized units of HFP, and about 13 wt. % of polymerized units of VDF has a Tm of about 240° C. By increasing the polymerized units of HFP/VDF, while reducing the polymerized units of TFE, the fluoropolymer becomes amorphous. An overview of crystalline and amorphous Fluoropolymers is described by Ullmann's Encyclopedia of Industrial Chemistry (7^{th} Edition, 2013 Wiley-VCH Verlag. 10. 1002/14356007.a11 393 pub 2) Chapter: Fluoropolymers, Organic.

In some embodiments, the crystalline fluoropolymers comprise little or no polymerized units of VDF. The amount of polymerized units of VDF is no greater than 5, 4, 3, 2, or 1 wt. % of the total crystalline fluoropolymer.

In some embodiments, the crystalline fluoropolymers comprises polymerized units of HFP. The amount of polymerized units of HFP can be at least 1, 2, 3, 4, 5 wt. % of the total crystalline fluoropolymer. In some embodiments, the amount of polymerized units of HFP is no greater than 15, 14, 13, 12, 11, or 10 wt. % of the total crystalline fluoropolymer.

In some embodiments, the fluoropolymers of the compositions described here comprise little or no polymerized units of vinylidene fluoride (VDF) (i.e. CH₂═CF₂) or VDF coupled to hexafluoropropylene (HFP). Polymerized units of VDF can undergo dehydrofluorination (i.e. an HF elimination reaction) as described in US2006/0147723. The reaction is limited by the number of polymerized VDF groups coupled to an HFP group contained in the fluoropolymer.

The crystalline fluoropolymer (e.g. particles) and amorphous fluoropolymer (e.g. particles) may be combined at a variety of ratios. For example, the coating composition contains about 5 to about 95 weight percent crystalline fluoropolymer (e.g. particles) and about 95 to about 5 weight percent amorphous fluoropolymer, based on the total weight percent of solids (i.e. excluding the solvent). In some embodiments, the coating composition contains about 10 to about 75 weight percent crystalline fluoropolymer (e.g. particles) and about 90 to about 25 weight amorphous fluoropolymer.

In some embodiments, the coating composition or fluoropolymer film contains at least 5, 10 or 15 weight percent ranging up to about 50, 55, 60, 65, 70, 75, or 80 weight percent crystalline fluoropolymer (e.g. particles) and about 20, 30, 40, or 50 to about 90 or 95 weight percent amorphous fluoropolymer. In some embodiments, the coating composition contains about 10 to about 30 weight percent crystalline fluoropolymer (e.g. particles) and about 90 to about 70 weight percent amorphous fluoropolymer.

In some embodiments, fluoropolymer composition comprises fluoropolymer particles have a particle size of greater than 1 micron. In typical embodiments, the fluoropolymer particles have an average particle size of no greater than 75, 70, 65, 60, 55, 50, 45, 35, 30, 30, 25, 20, 15, 10, or 5 microns. In some embodiments, the particle size of the fluoropolymer particles is less than the thickness of the fluoropolymer coating or fluoropolymer film layer. The average particle size is typically reported by the supplier. The particle size of the fluoropolymer particles of the fluoropolymer coating or fluoropolymer film layer can be determined by microscopy.

In some embodiments, the fluoropolymer particles comprise a mixture of particles including fluoropolymer particles having a particle size of greater than 1 micron and fluoropolymer particles having a particle size of 1 micron or less. In some embodiments, the submicron fluoropolymer particle size range may be about 50 to about 1000 nm, or about 50 to about 400 nm, or about 50 to about 200 nm.

The weight ratio of fluoropolymer particles having a particle size greater than 1 micron to fluoropolymer particles having a particle size of 1 micron or less typically ranges from 1:1 to 10:1. In some embodiments, the weight ratio of larger to smaller fluoropolymer particles is at least 2:1, 3:1, 4:1, 5:1, 6:1, 7:1, 8:1 or 9:1.

The crystalline fluoropolymer (e.g. particles) are insoluble in fluorinated solvent. The crystalline fluoropolymer (e.g. particles) are also insoluble in non-fluorinated organic solvent such as methyl ethyl ketone (“MEK”), tetrahydrofuran (“THF”), ethyl acetate or N-methyl pyrrolidinone (“NMP”). By insoluble it is meant that less than 1, 0.5, 0.1, 0.01, 0.001 wt % wt. % of the fluoropolymer is soluble in fluorinated solvent.

As evident by Table 8 of the forthcoming examples, when the amorphous fluoropolymer alone (i.e. without the dispersed crystalline fluoropolymer particles) is heated to temperatures of 150, 200, or 300° C., the amorphous fluoropolymer remains soluble in fluorinated (e.g. HFE-7500) solvent. However, when the amorphous fluoropolymer together with the dispersed crystalline fluoropolymer particles is heated to temperatures of 200 or 300° C., the composition becomes insoluble in fluorinated (e.g. HFE-7500) solvent. Without intending to be bound by theory, it is surmised that the TFE units of the crystalline fluoropolymer particles co-crystallize or otherwise interact with the TFE units of the amorphous fluoropolymer, thereby (e.g. physically) crosslinking the amorphous fluoropolymer. In this embodiment, the fluoropolymer layer of the coated substrate or article may be characterized as “physically crosslinked”.

As evident by Tables 9 and 10, when the amorphous and crystalline fluoropolymer are a coagulated latex mixture, the fluoropolymer composition can have a normalized crystallinity of greater than 100%. In some embodiments, the normalized crystallinity may range up to 105, 110, 115, 120, 125, 130, 135, 140, 145, 150, 155, or 160%.

As evident by Tables 11, when the amorphous and crystalline fluoropolymer are dry blended and melted, the fluoropolymer composition typically has a normalized crystallinity of less than 100%. The normalized crystallinity may be at least 70 or 75%.

The crystallinity and normalized crystallinity can be determined according to the test method described in the examples.

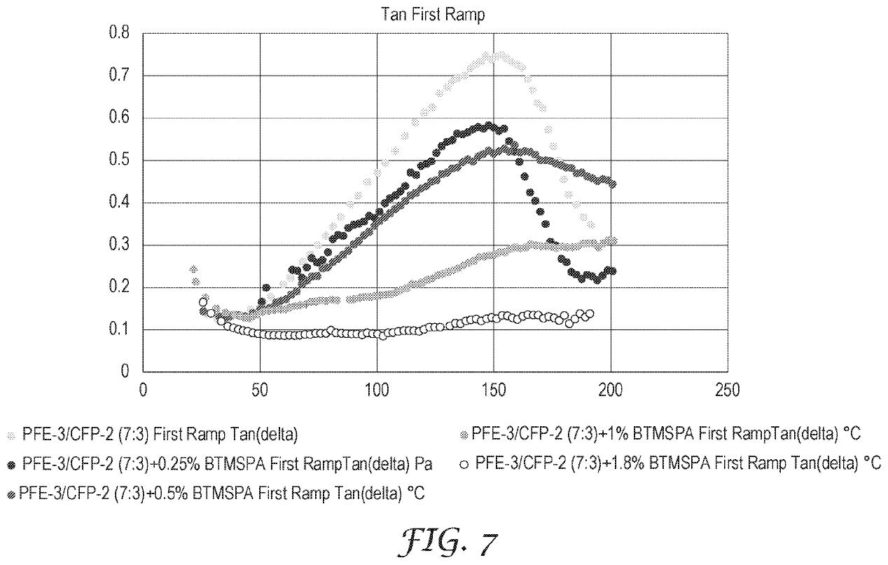

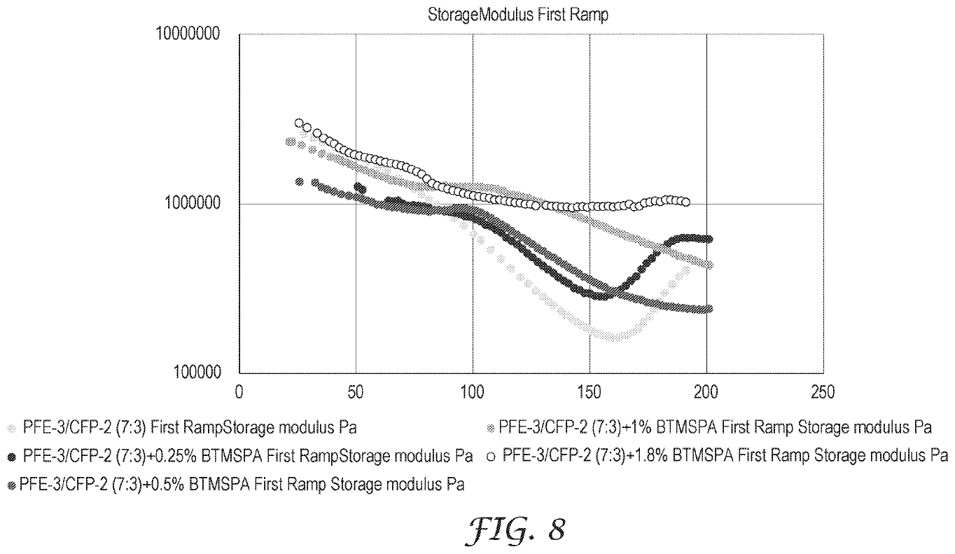

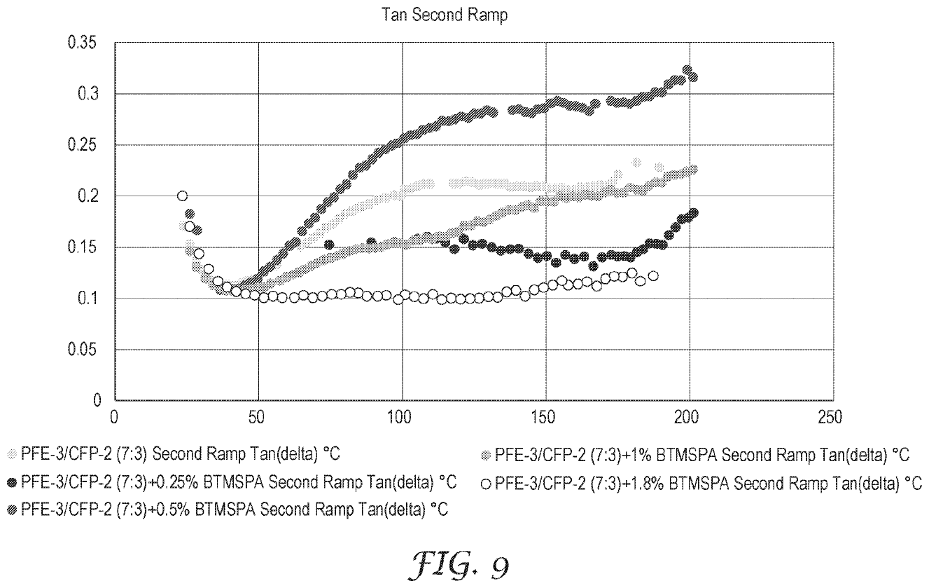

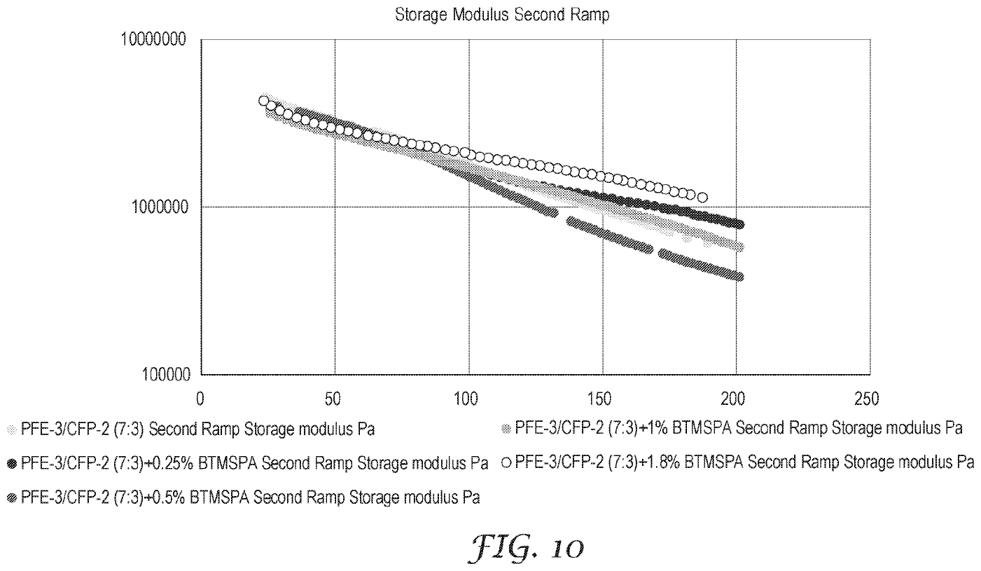

With reference to FIGS. 7 and 8, in some embodiments, the fluoropolymer composition has a higher (e.g. first cycle) tan delta at a temperature in a range from 100° C. to a temperature below the melt temperature of the fluoropolymer(s) than the same fluoropolymer composition further comprising crosslinks of a chemical curing agent. In some embodiments, the fluoropolymer composition has a lower (e.g. first cycle) storage modulus at a temperature in a range from 100° C. to a temperature below the melt temperature of the fluoropolymer(s) than the same fluoropolymer composition further comprising crosslinks of a chemical curing agent. In some embodiments, the fluoropolymer composition has an irreversible second cycle storage modulus increase (relative to the first cycle storage modulus) at a temperature in a range from 100° C. to a temperature below the melt temperature of the fluoropolymer(s). The irreversible storage modulus increase is evident by comparing the first cycle storage modulus to the second cycle storage modulus. As noted by FIG. 10, the second cycle storage modulus can be similar to the same composition further comprising a chemical curing agent.

In some embodiments, the temperature(s) at which the fluoropolymer composition has a higher (e.g. first cycle) tan delta and/or lower (e.g. first cycle) storage modulus and/or irreversible increase in storage modulus (difference between first and second cycle) is 110, 115, 120, 125, 130, 135, 140, 145, 150, 155, 160, 165, 170, 175, 180, 185 190, 195 or 200° C. In other embodiments, the temperature(s) at which the fluoropolymer composition has a higher (e.g. first cycle) tan delta and/or lower (e.g. first cycle) storage modulus and/or irreversible increase in storage modulus is no greater than 350, 345, 340, 335, 330, 325, 320, 315, 310, 305, 300, 295, 290, 285, 280, 275, 270, 265, 260, 255, 250, 254, 240, 235, 230, 225, 220, 215, 210° C. It is appreciated that the higher (e.g. first cycle) tan delta and/or lower (e.g. first cycle) storage modulus and/or higher (e.g. second cycle) storage modulus occurs over a range of temperatures, such range being formed from the specific temperatures just described. For example, in some embodiments, the fluoropolymer composition has a (e.g. first cycle) higher tan delta and/or lower first cycle storage modulus than the same fluoropolymer composition further comprising crosslinks of a chemical curing agent is at a temperature range from at least 100, 110, or 120° C. to no greater than 155, 165, or 175° C.

In some embodiments, the fluoropolymer composition has a first cycle storage modulus of less than 0.30 MPa (e.g. at 150° C.). In some embodiments, the first cycle storage modulus at a higher temperature (e.g. 190° C.) is greater than the first cycle storage modulus at a lower temperature (e.g. 150° C.). The first cycle storage modulus at a higher temperature (e.g. 190° C.) can be at least 0.1 MPa, 0.2 MPa or 0.3 MPa as compared to the first cycle storage modulus at a lower temperature (e.g. 150° C.). In some embodiments, the storage modulus at a higher temperature (e.g. at 190° C.) can be at least 1.25X, 1.5X, 1.75X, 2X, or 2.25X the storage modulus at a lower temperature (e.g. 150° C.). This characteristic allows the fluoropolymer composition to be thermally processed at lower temperatures.

In some embodiments, the (e.g. second cycle) tan delta at a lower temperature (e.g. 150° C.) ranges from 0.1 to 0.3 MPa. In some embodiments, the (e.g. second cycle) tan delta at a lower temperature (e.g. 150° C.) is at least 0.15 or 0.20 MPa. The storage modulus and tan delta can be determined according to the test method described in the examples.

### Fluoropolymer Coating Compositions

The fluoropolymer coating compositions comprise at least one fluorinated solvent. The solvent is capable of dissolving the amorphous fluoropolymer. Thus, the amorphous fluoropolymer is soluble in fluroinated solvent. The fluroinated solvent will subsequently be described in greater detail. In some embodiments, the fluorinated solvent is solvent is a partially fluorinated ether such as 3-ethoxy perfluorinated 2-methyl hexane, or 3-methoxy perfluorinated 4-methyl. By soluble it is meant that at least 10, 15, 20, 25, or 30 wt. % of the uncrosslinked fluoropolymer is soluble in fluorinated solvent.

The crystalline fluoropolymer (e.g. particles) are insoluble in the fluorinated solvent. In some embodiments, the fluoropolymer composition of the fluoropolymer layer is also typically insoluble in the fluorinated solvent.

The fluoropolymer coating compositions may be prepared by mixing the fluoropolymers, optional additives and the fluorinated solvent. In some embodiments, the amorphous fluoropolymer is first dissolved in the fluorinated solvent and the crystalline fluoropolymer (e.g. particles) and other additives added thereafter.

The fluorinated solvent is typically present in an amount of at least 25% by weight based on the total weight of the coating composition. In some embodiments, the solvent is present in an amount of at least 30, 35, 40, 45, 50, 55, 60, 65, 70, 75, 80, 85, 90, 95% or greater based on the total weight of the coating composition.

The fluoropolymer coating composition typically comprises at least 0.01, 0.02, 0.03, 0.03, 0.04, 0.04, 0.05, 0.06, 0.7, 0.8. 0.9 or 1% by weight of fluoropolymer, based on the weight of the total coating composition. In some embodiments, the fluoropolymer coating composition comprises at least 2, 3, 4, or 5% by weight of fluoropolymer. In some embodiments, the fluoropolymer coating composition comprises at least 6, 7, 8, 9 or 10% by weight of fluoropolymer. The fluoropolymer coating composition typically comprises no greater than 50, 45, 40, 35, 30, 25, or 20% by weight of fluoropolymer, based on the weight of the total coating composition.

Optimum amounts of solvent and fluoropolymers may depend on the final application and may vary. For example, to provide thin coatings, very dilute solutions of fluoropolymer in the solvent may be desired, for example amounts of from 0.01% by weight to 5% by weight of fluoropolymer. Also for application by spray coating composition of low viscosity may be preferred over solutions with high viscosity. The concentration of fluoropolymer in the solution affects the viscosity and may be adjusted accordingly. An advantage of the present disclosure is that also solutions with high concentrations of fluoropolymer can be prepared that still provide clear liquid composition of low viscosity.

In some embodiments, the fluoropolymer coating compositions may be liquids. The liquids may have, for example, a viscosity of less than 2,000 mPas at room temperature (20° C. +/−2° C.). In other embodiments, the fluoropolymer coating solution compositions are pastes. The pastes may have, for example, a viscosity of from 2,000 to 100.000 mPas at room temperature (20° C. +/−2° C.).

The solvent is a liquid at ambient conditions and typically has a boiling point of greater than 50° C. Preferably, the solvent has a boiling point below 200° C. so that it can be easily removed. In some embodiments, the solvent has a boiling point below 190, 180, 170, 160, 150, 140, 130, 120, 110, or 100° C.

The solvent is partially fluorinated or perfluorinated. Thus, the solvent is non-aqueous. Various partially fluorinated or perfluorinated solvents are known including perfluorocarbons (PFCs), hydrochlorofluorocarbons (HCFCs), perfluoropolyethers (PFPEs), and hydrofluorocarbons (HFCs), as well as fluorinated ketones and fluorinated alkyl amines.

In some embodiments, the solvent has a global warming potential (GWP, 100 year ITH) of less than 1000, 900, 800, 700, 600, 500, 400, 300, 200 or 100. The GWP is typically greater than 0 and may be at least 10, 20, 30, 40, 50, 60, 70, or 80.

As used herein, GWP is a relative measure of the global warming potential of a compound based on the structure of the compound. The GWP of a compound, as defined by the Intergovernmental Panel on Climate Change (IPCC) in 1990 and updated in subsequent reports, is calculated as the warming due to the release of 1 kilogram of a compound relative to the warming due to the release of 1 kilogram of CO₂ over a specified integration time horizon (ITH).

$${GWP}_{x} = \frac{{\int }_{0}^{ITH} {F}_{x} {C}_{x ∘} exp ( - t / {τ}_{x} ) dt}{{\int }_{0}^{ITH} {F}_{{CO}_{2}} {C}_{{CO}_{2}} ( t ) dt}$$

where F is the radiative forcing per unit mass of a compound (the change in the flux of radiation through the atmosphere due to the IR absorbance of that compound), C₀ is the atmospheric concentration of a compound at initial time, τ is the atmospheric lifetime of a compound, t is time, and x is the compound of interest.

In some embodiments, the solvent comprises a partially fluorinated ether or a partially fluorinated polyether. The partially fluorinated ether or polyether may be linear, cyclic or branched. Preferably, it is branched. Preferably it comprises a non-fluorinated alkyl group and a perfluorinated alkyl group and more preferably, the perfluorinated alkyl group is branched.

In one embodiment, the partially fluorinated ether or polyether solvent corresponds to the formula:

Rf—O—R

wherein Rf is a perfluorinated or partially fluorinated alkyl or (poly)ether group and R is a non-fluorinated or partially fluorinated alkyl group. Typically, Rf may have from 1 to 12 carbon atoms. Rf may be a primary, secondary or tertiary fluorinated or perfluorinated alkyl residue. This means, when Rf is a primary alkyl residue the carbon atom linked to the ether atoms contains two fluorine atoms and is bonded to another carbon atom of the fluorinated or perfluorinated alkyl chain. In such case Rf would correspond to R_{f}¹—CF₂— and the polyether can be described by the general formula: R_{f}¹—CF₂—O—R.

When Rf is a secondary alkyl residue, the carbon atom linked to the ether atom is also linked to one fluorine atoms and to two carbon atoms of partially and/or perfluorinated alkyl chains and Rf corresponds to (R_{f}²R_{f}³)CF—. The polyether would correspond to (R_{f}²R_{f}³)CF—O—R.

When Rf is a tertiary alkyl residue the carbon atom linked to the ether atom is also linked to three carbon atoms of three partially and/or perfluorinated alkyl chains and Rf corresponds to (R_{f}⁴R_{f}⁵R_{f}⁶)—C—. The polyether then corresponds to (R_{f}⁴R_{f}⁵R_{f}⁶)—C—OR. R_{f}¹; R_{f}²; R_{f}³; R_{f}⁴; R_{f}⁵; R_{f}⁶ correspond to the definition of Rf and are a perfluorinated or partially fluorinated alkyl group that may be interrupted once or more than once by an ether oxygen. They may be linear or branched or cyclic. Also a combination of polyethers may be used and also a combination of primary, secondary and/or tertiary alkyl residues may be used.

An example of a solvent comprising a partially fluorinated alkyl group includes C₃F₇OCHFCF₃ (CAS No. 3330-15-2).

An example of a solvent wherein Rf comprises a perfluorinated (poly)ether is C₃F₇OCF(CF₃)CF₂OCHFCF₃ (CAS No. 3330-14-1).

In some embodiments, the partially fluorinated ether solvent corresponds to the formula:

CpF2p+1—O—CqH2q+1

wherein q is an integer from 1 to and 5, for example 1, 2, 3, 4 or 5, and p is an integer from 5 to 11, for example 5, 6, 7, 8, 9, 10 or 11. Preferably, CₚF₂ₚ₊₁ is branched. Preferably, CₚF₂ₚ₊₁ is branched and q is 1, 2 or 3.

Representative solvents include for example 1,1,1,2,2,3,4,5,5,5-decafluoro-3-methoxy-4-(trifluoromethyl)pentane and 3-ethoxy-1,1,1,2,3,4,4,5,5,6,6,6-dodecafluroro-2-(trifluoromethyl)hexane. Such solvents are commercially available, for example, under the trade designation NOVEC from 3M Company, St. Paul, MN.

The fluorinated (e.g. ethers and polyethers) solvents may be used alone or in combination with other solvents, which may be fluorochemical solvents or non-fluorochemical solvents. When a non-fluorochemical solvent is combined with a fluorinated solvent, the concentration non-fluorochemical solvent is typically less than 30, 25, 20, 15, 10 or 5 wt-% with respect to the total amount of solvent. Representative non-fluorochemical solvents include ketones such as acetone, MEK, methyl isobutyl ketone, methyl amyl ketone and NMP; ethers such as tetrahydrofuran, 2-methyl tetrahydrofuran and methyl tetrahydrofurfuryl ether; esters such as methyl acetate, ethyl acetate and butyl acetate; cyclic esters such as delta-valerolactone and gamma-valerolactone.

The coating composition described herein including fluorinated solvent is “stable, meaning that the coating composition remains homogeneous when stored for at least 24 hours at room temperature in a sealed container. In some embodiments, the coating composition is stable for one week or more. “Homogeneous” refers to a coating composition that does not exhibit a visibly separate precipitate or visibly separate layer when freshly shaken, placed in a 100 ml glass container and allowed to stand at room temperature for at least 4 hours.

### Additives

Compositions containing curable fluoroelastomers may further contain additives as known in the art. Examples include acid acceptors. Such acid acceptors can be inorganic or blends of inorganic and organic acid acceptors. Examples of inorganic acceptors include magnesium oxide, lead oxide, calcium oxide, calcium hydroxide, dibasic lead phosphate, zinc oxide, barium carbonate, strontium hydroxide, calcium carbonate, hydrotalcite, etc. Organic acceptors include epoxies, sodium stearate, and magnesium oxalate. Particularly suitable acid acceptors include magnesium oxide and zinc oxide. Blends of acid acceptors may be used as well. The amount of acid acceptor will generally depend on the nature of the acid acceptor used. Typically, the amount of acid acceptor used is between 0.5 and 5 parts per 100 parts of fluorinated polymer.

The fluoropolymer composition may contain further additives, such as stabilizers, surfactants, ultraviolet (“UV”) absorbers, antioxidants, plasticizers, lubricants, fillers, and processing aids typically utilized in fluoropolymer processing or compounding, provided they have adequate stability for the intended service conditions. A particular example of additives includes carbon particles, like carbon black, graphite, soot. Further additives include but are not limited to pigments, for example iron oxides, titanium dioxides. Other additives include but are not limited to clay, silicon dioxide, barium sulphate, silica, glass fibers, or other additives known and used in the art.

In some embodiments, the fluoropolymer composition comprises silica, glass fibers, thermally conductive particles, or a combination thereof. Any amount of silica and/or glass fibers and/or thermally conductive particles may be present. In some embodiments, the amount of silica and/or glass fibers is at least 0.05, 0.1, 0.2, 0.3 wt. % of the total solids of the composition. In some embodiments, the amount of silica and/or glass fibers is no greater than 5, 4, 3, 2, or 1 wt. % of the total solids of the composition. Small concentrations of silica can be utilized to thicken the coating composition. Further, small concentrations of glass fibers can be used to improve the strength of the fluoropolymer film. In other embodiments, the amount of glass fibers can be at least 5, 10, 15, 20, 25, 35, 40, 45 or 50 wt-% of the total solids of the composition. The amount of glass fibers is typically no greater than 55, 50, 45, 40, 35, 25, 20, 15, or 10 wt. %. In some embodiments, the glass fibers have a mean length of at least 100, 150, 200, 250, 300, 350, 400, 450, 500 microns. In some embodiments, the glass fibers have a mean length of at least 1, 2, or 3 mm and typically no greater than 5 or 10 mm. In some embodiments, the glass fibers have a mean diameter of at least 1, 2, 3, 4, or 5 microns and typically no greater than 10, 15, 30, or 25 microns. The glass fibers can have aspect ratio of at least 3:1, 5:1, 10:1, or 15:1.

In some embodiments, the fluoropolymer composition is free of (e.g. silica) inorganic oxide particles. In other embodiments, the fluoropolymer composition comprises (e.g. silica and/or thermally conductive) inorganic oxide particles. In some embodiments, the amount of (e.g. silica and/or thermally conductive) inorganic oxide particles is at least 5, 10, 15, 20, 25, 30, 35, 40, 45 or 50 wt. % of the total solids of the composition. In some embodiments, the amount of (e.g. silica and/or thermally conductive) inorganic oxide particles is no greater than 90, 85, 80, 75, 70, or 65 wt. % of the total solids of the composition. Various combinations of silica and thermally conductive particles can be utilized. In some embodiments, the total amount of (e.g. silica and thermally conductive) inorganic oxide particles or the amount of a specific type of silica particle (e.g. fused silica, fumed silica, glass bubbles, etc.) or thermally conductive particle (e.g. boron nitride, silicon carbide, aluminum oxide, aluminum trihydrate) is no greater than 60, 55, 50, 45, 40, 35, 30, 25, 20, 15, 10, or 5 wt. % of the total solids of the composition. Higher concentrations of (e.g. silica) inorganic oxide particles can be favorable to further reducing the dielectric properties. Thus, the compositions including (e.g. silica) inorganic oxide particles can have even lower dielectric properties than the fluoropolymer composition alone.

In some embodiments, the (e.g. silica) inorganic oxide particles and/or glass fibers have a dielectric contant at 1 GHz of no greater than 7, 6.5, 6, 5.5, 5, 4.5, or 4. In some embodiments, the (e.g. silica) inorganic oxide particles and/or glass fibers have a dissipation factor at 1 GHz of no greater than 0.005, 004, 0.003, 0.002, or 0.0015.

In some embodiments, the composition comprises inorganic oxide particles or glass fibers that comprise predominantly silica. In some embodiments, the amount of silica is typically at least 50, 60, 70, 75, 80, 85, or 90 wt. % of the inorganic oxide particles or glass fibers, In some embodiments, the amount of silica is typically at least 90, 91, 92, 93, 94, 95, 96, 97, 98, 99, or greater (e.g. at least 99.5, 99.6, or 99.7) wt-% silica. Higher silica concentrations typically have lower dielectric constants. In some embodiments, (e.g. fused) silica particle can further comprise small concentration of other metals/metal oxides such as Al₂O₃, Fe₂O₅, TiO₂, K₂O, CaO, MgO and Na₂O. In some embodiments, the total amount of such metals/metal oxides (e.g. Al₂O₃, CaO and MgO) is independently no greater than 30, 25, 20, 15, or 10 wt. %. In some embodiments, the inorganic oxide particles or glass fibers may comprise B₂O₃ The amount of B₂O₃ can range up to 25 wt. % of the inorganic oxide particles or glass fibers. In other embodiments, (e.g. fumed) silica particle can further comprise small concentration of additional metals/metal oxides such as Cr, Cu, Li, Mg, Ni, P and Zr. In some embodiments, the total amount of such metals or metal oxides is no greater 5, 4, 3, 2, or 1 wt. %. In some embodiments, the silica may be described as quartz. The amount of non-silica metals or metal oxides can be determined by uses of inductively coupled plasma mass spectrometry. The (e.g. silica) inorganic oxides particles are typically dissolved in hydrofluroic acid and distilled as H₂SiF₆ at low temperatures.

In some embodiments, the inorganic particles may be characterized as an “agglomerate”, meaning a weak association between primary particles such as particles held together by charge or polarity. Agglomerate are typically physically broken down into smaller entities such as primary particles during preparation of the coating solution. In other embodiments, the inorganic particles may be characterized as an “aggregate”, meaning strongly bonded or fused particles, such as covalently bonded particles or thermally bonded particles prepared by processes such as sintering, electric arc, flame hydrolysis, or plasma. Aggregates are typically no broken down into smaller entities such as primary particles during preparation of the coating solution. “Primary particle size” refers to the mean diameter of a single (non-aggregate, non-agglomerate) particle.

The (e.g. silica) particles may have various shapes such as spherical, ellipsoid, linear or branched. Fused and fumed silica aggregates are more commonly branched. The aggregate size is commonly at least 10X the primary particle size of discrete part.

In other embodiments, the (e.g. silica) particles may be characterized as glass bubbles. The glass bubble may be prepared from soda lime borosilicate glass. In this embodiment, the glass may contain about 70 percent silica (silicon dioxide), 15 percent soda (sodium oxide), and 9 percent lime (calcium oxide), with much smaller amounts of various other compounds.

In some embodiments, the inorganic oxide particles may be characterized as (e.g. silica) nanoparticles, having a mean or median particles size less than 1 micron. In some embodiments, the mean or median particle size of the (e.g. silica) inorganic oxide particles is at 500 or 750 nm. In other embodiments, the mean particle size of the (e.g. silica) inorganic oxide particles may be at least 1, 1.5, 2, 2.5, 3, 3.5, 4, 4.5, 5, 5.5, 6, 6.5, 7, 7.5, 8, 8.5, 9, 9.5 or 10 microns. In some embodiments, the mean particle size in no greater than 30, 25, 20, 15, or 10 microns. In some embodiments, the composition comprises little or no (e.g. colloidal silica) nanoparticles having a particle of 100 nanometers or less. The concentration of (e.g. colloidal silica) nanoparticles is typically less than (10, 9, 8, 7, 6, 5, 4, 3, 2, or 1 wt. %) The inorganic oxide (e.g. silica particle) may comprise a normal distribution of particle sizes having a single peak or a distribution of particles having two or more peaks.

In some embodiments, no greater than 1 wt. % of the (e.g. silica) inorganic oxide particles have a particle size greater than or equal to 3 or 4 microns. In some embodiments, no greater than 1 wt. % of the (e.g. silica) inorganic oxide particles have a particle size greater than or equal to 5 or 10 microns. In other embodiments, no greater than 5, 4, 3, 2, or 1 wt. % of the particles have a particle size greater than 45 microns. In some embodiments, no greater than 1 wt. % of the particles have a particle size ranging from 75 to 150 microns.

In some embodiments, the mean or median particle size refers to the “primary particle size” referring to the mean or median diameter of discrete a non-aggregated, non-agglomerated particles. For example, the particle size of colloidal silica or glass bubbles is typically the mean or median particle size of In preferred embodiments, the mean or median particle size refers to the mean or median diameter of the aggregates. The particle size of the inorganic particles can be measured using transmission electron microscopy. The particle size of the fluoropolymer coating solution can be measured using dynamic light scattering.

In some embodiments, the (e.g. silica) inorganic particles have a specific gravity ranging from 2.18 to 2.20 g/cc.

Aggregated particles, such as in the case of fumed and fused (e.g. silica) particles, can have a lower surface area than primary particles of the same size. In some embodiments, the (e.g. silica) particle have a BET surface area ranging from about 50 to 500 m²/g. In some embodiments, the BET surface area is less than 450, 400, 350, 300, 250, 200, 150, or 100 m²/g. In some embodiments, the inorganic nanoparticles may be characterized as colloidal silica. It is appreciated that unmodified colloidal silica nanoparticles commonly comprise hydroxyl or silanol functional groups on the nanoparticle surface and are typically characterized as hydrophilic.

In some embodiments, (e.g. silica aggregate) inorganic particles and especially colloidal silica nanoparticles are surface treated with a hydrophobic surface treatment. Common hydrophobic surface treatments include compounds such as alkoxysilanes (e.g. octadecyltriethoxysilane), silazane, or siloxanes. Various hydrophobic fumed silicas are commercially available from AEROSIL™, Evonik, and various other suppliers. Representative hydrophobic fumed silica include AEROSIL™ grades R 972, R 805, RX 300, and NX 90 S.

In some embodiments, (e.g. silica aggregate) inorganic particles are surface treated with a fluorinated alkoxysilane silane compound. Such compounds typically comprise a perfluoroalkyl or perfluoropolyether group. The perfluoroalkyl or perfluoropolyether group typically has no greater than 4, 5, 6, 7, 8 carbon atoms. The alkoxysilane group can be bonded to the alkoxy silane group with various divalent linking groups including alkylene, urethane, and —SO₂N(Me)—. Some representative fluorinated alkoxy silanes are described in U.S. Pat. No. 5,274,159 and WO2011/043973; incorporated herein by reference. Other fluorinated alkoxy silanes are commercially available.

In some embodiments, the fluoropolymer composition comprises thermally conductive particles.

In some embodiments, the thermally conductive inorganic particles are preferably an electrically non-conductive material. Suitable electrically non-conductive, thermally conductive materials include ceramics such as metal oxides, hydroxides, oxyhydroxides, silicates, borides, carbides, and nitrides. Suitable ceramic fillers include, e.g., silicon oxide, zinc oxide, alumina trihydrate (ATH) (also known as hydrated alumina, aluminum oxide, and aluminum trihydroxide), aluminum nitride, boron nitride, silicon carbide, and beryllium oxide. Other thermally conducting fillers include carbon-based materials such as graphite and metals such as aluminum and copper. Combinations of different thermally conductive materials may be utilized. Such materials are not electrically conductive, i.e. have an electronic band gap greater than 0 eV and in some embodiments, at least 1, 2, 3, 4, or 5 eV. In some embodiments, such materials have an electronic band gap no greater than 15 or 20 eV. In this embodiment, the composition may optionally further comprise a small concentration of thermally conductive particles having an electronic band gap of greater than 0 eV or greater than 20 eV.

In favored embodiments, the thermally conductive particles comprise a material having a bulk thermal conductivity >10 W/m*K. The thermal conductivity of some representative inorganic materials is set forth in the following table.

Thermally Conductive Materials

| | Thermal | | | |
|---|---|---|---|---|
| | Conductivity | Electronic | | |
| Material | (W/m*K) | Band Gap (eV) | Density | |
| α-Aluminum Oxide¹ | 30 | 5-9 | 3.95 | g/cc |
| Alumina Trihydrate² | 21 | | 2.42-2.45 | g/cc |
| Silicon Carbide (SiC)¹ | 120 | 2.4 | 3.21 | g/cc |
| Hexagonal Boron | 185-300 | 2.1 | 2.1 | g/cc |
| Nitride (BN)¹ | | | | |

In some embodiments, the thermally conductive particles comprise material(s) having a bulk thermal conductivity of at least 15 or 20 W/m*K. In other embodiments, the thermally conductive particles comprise material(s) having a bulk thermal conductivity of at least 25 or 30 W/m*K. In yet other embodiments, the thermally conductive particles comprise material(s) having a bulk thermal conductivity of at least 50, 75 or 100 W/m*K. In yet other embodiments, the thermally conductive particles comprise material(s) having a bulk thermal conductivity of at least 150 W/m*K. In typical embodiments, the thermally conductive particles comprise material(s) having a bulk thermal conductivity of no greater than about 350 or 300 W/m*K.

Thermally conductive particles are available in numerous shapes, e.g. spheres and acicular shapes that may be irregular or plate-like. In some embodiments, the thermally conductive particles are crystals, typically have a geometric shape. For example, boron nitride hexagonal crystals are commercially available from Momentive. Further, alumina trihydrate is described as a hexagonal platelet. Combinations of particles with different shapes may be utilized. The thermally conductive particles generally have an aspect ratio less than 100:1, 75:1, or 50:1. In some embodiment, the thermally conductive particles have an aspect ratio less than 3:1, 2.5:1, 2:1, or 1.5:1. In some embodiments, generally symmetrical (e.g., spherical, semi-spherical) particles may be employed.

Boron nitride particles are commercially available from 3M as “3M™ Boron Nitride Cooling Fillers”.

In some embodiments, the boron nitride particles has a bulk density of at least 0.05, 0.01, 0.15, 0.03 g/cm³ ranging up to about 0.60, 0.70, or 0.80 g/cm³. The surface area of the boron nitride particle can be <25, <20, <10, <5, or <3 m²/g. The surface area is typically at least 1 or 2 m²/g.

In some embodiments, the particle size, d(0.1), of the boron nitride (e.g. platelet) particles ranges from about 0.5 to 5 microns. In some embodiments, the particle size, d(0.9), of the boron nitride (e.g. platelet) particles is at least 5 ranging up to 20, 25, 30, 35, 40, 45, or 50 microns.

### Methods of Making Fluoropolymer Composition & Coated Substrates

In some embodiments, a method of making a coated substrate is described comprising providing a fluoropolymer composition comprising an amorphous fluoropolymer and crystalline fluoropolymer as described herein; and applying the fluoropolymer composition to a substate.

In some embodiments, the fluoropolymer composition further comprises a fluorinated solvent; and the method further comprises removing the fluorinated solvent after applying the fluoropolymer composition to the substrate.

The fluoropolymer coating compositions described herein may be adjusted (by the solvent content) to a viscosity to allow application by different coating methods, including, but not limited to spray coating or printing (for example but not limited to ink-printing, 3D-printing, screen printing), painting, impregnating, roller coating, bar coating, dip coating and solvent casting.

The solvent may be reduced or completely removed, for example for evaporation, drying or by boiling it off After removal of the solvent the composition may be characterized as “dried”. The coated substrate may be dried at temperatures at or above the boiling point of the fluorinated solvent. The amorphous fluoropolymer is soluble in the fluorinated solvent of the coating solution; wherein the crystalline fluoropolymer (e.g. particles) are not soluble in the fluorinated solvent of the coating solution.

In some embodiments, the method further comprises heating the substrate comprising the fluoropolymer composition to a temperature above the melt temperature of the fluoropolymer particles to sinter the fluoropolymer particles.

In other embodiments, the fluoropolymer composition is prepared by blending the amorphous fluoropolymer with the crystalline fluoropolymer particles and extruding the fluoropolymer composition onto the substrate. The amorphous and crystalline fluoropolymers can be combined in conventional rubber processing equipment to provide a solid mixture, i.e. a solid polymer containing the additional ingredients, also referred to in the art as a “compound”. Typical equipment includes rubber mills, internal mixers, such as Banbury mixers, and mixing extruders. During mixing the components and additives are distributed uniformly throughout the resulting fluorinated polymer “compound” or polymer sheets. The compound is then preferably comminuted, for example by cutting it into smaller pieces and is then dissolved in the solvent.

In yet another embodiment, the method comprises a laminating a fluoropolymer film to the substrate with heat and pressure. The fluoropolymer film can be heated laminated at temperatures ranging from 120° C. to 350° C. In some embodiments, the fluoropolymer film can be heat laminated at a temperature less than 325 or 300°. In some embodiments, the fluoropolymer film can he heat laminated at a temperature no greater than 290, 280, 270, 260, 250, 240, 230, 220, 210, or 200° C. Lower temperatures are amenable to bonding heat sensitive substrate and reducing manufacturing energy costs. The fluoropolymer film may be provided by extrusion or coating and drying the coating solution on a release liner.

The compositions may be used for impregnating substrates, printing on substrates (for example screen printing), or coating substrates, for example but not limited to spray coating, painting dip coating, roller coating, bar coating, solvent casting, paste coating. The substrate may be organic, inorganic, or a combination thereof. Suitable substrates may include any solid surface and may include substrate selected from glass, plastics (e.g. polycarbonate), composites, metals (stainless steel, aluminum, carbon steel), metal alloys, wood, paper among others. The coating may be colored in case the compositions contains pigments, for example titanium dioxides or black fillers like graphite or soot, or it may be colorless in case pigments or black fillers are absent. Bonding agents and primers may be used to pretreat the surface of the substrate before coating. For example, bonding of the coating to metal surfaces may be improved by applying a bonding agent or primer. Examples include commercial primers or bonding agents, for example those commercially available under the trade designation CHEMLOK.

The fluoropolymer can exhibit good adhesion to various substrates (e.g. glass, polycarbonate, and metals, such as copper. In some embodiment, the substrate has an average peak to valley heigh surface roughness (i.e. Rz) of about 1 to 1.5 microns. In other embodiments, the substrate has an Rz of greater than 1.5, 2. 2.5, or 3 microns. In some embodiment, the substrate has an Rz) of no greater than 5, 4, 3, 2 or 1.5 microns. For example, in some embodiments, the T-peel to copper foil is at least 5, 6, 7, 8, 9 or 10 N/cm ranging up to 15, 20, 25 30, or 35 N/cm or greater as determined by the test method described in the examples.

In some embodiments, the fluoropolymer composition dried has hydrophobic and oleiphobic properties, as determined by Contact Angle Measurements (as determined according to the test method described in the examples). In some embodiments, the static, advancing and/or receding contact angle with water can be at least 100, 105, 110, 115, 120, 125 and typically no greater than 130 degrees. In some embodiments, the advancing and/or receding contact angle with hexadecane can be at least 60, 65, 70, or 75 degrees.

As used herein the term “partially fluorinated alkyl” means an alkyl group of which some but not all hydrogens bonded to the carbon chain have been replaced by fluorine. For example, an F₂HC—, or an FH₂C— group is a partially fluorinated methyl group. Alkyl groups where the remaining hydrogen atoms have been partially or completely replaced by other atoms, for example other halogen atoms like chlorine, iodine and/or bromine are also encompassed by the term “partially fluorinated alkyl” as long as at least one hydrogen has been replaced by a fluorine. For example, residues of the formula F₂ClC— or FHClC— are also partially fluorinated alkyl residues.

A “partially fluorinated ether” is an ether containing at least one partially fluorinated group, or an ether that contains one or more perfluorinated groups and at least one non-fluorinated or at least one partially fluorinated group. For example, F₂HC—O—CH₃, F₃C—O—CH₃, F₂HC—O—CFH₂, and F₂HC—O—CF₃ are examples of partially fluorinated ethers. Ethers groups where the remaining hydrogen atoms have been partially or completely replaced by other atoms, for example other halogen atoms like chlorine, iodine and/or bromine are also encompassed by the term “partially fluorinated alkyl” as long as at least one hydrogen has been replaced by a fluorine. For example, ethers of the formula F₂ClC—O—CF₃ or FHClC—O—CF₃ are also partially fluorinated ethers.

The term “perfluorinated alkyl” or “perfluoro alkyl” is used herein to describe an alkyl group where all hydrogen atoms bonded to the alkyl chain have been replaced by fluorine atoms. For example, F₃C— represents a perfluoromethyl group.

A “perfluorinated ether” is an ether of which all hydrogen atoms have been replaced by fluorine atoms. An example of a perfluorinated ether is F₃C—O—CF₃.

The following examples are provided to further illustrate the present disclosure without any intention to limit the disclosure to the specific examples and embodiments provided.

### Examples

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Missouri, or may be synthesized by known methods. Table 1 (below) lists materials used in the examples and their sources.

TABLE 1
Materials List

| | | |
|---|---|---|
| DESIGNATION | DESCRIPTION | SOURCE |

AMORPHOUS PERFLUOROPOLYMERS

| | | |
|---|---|---|
| PFE-1 | Coagulated gum obtained from 30 wt. % solids aqueous | 3M Dyneon, St. |
| | perfluoroelastomer latex - 50.4 wt. % PMVE, 49.6 wt. % | Paul, MN |
| | TFE, and 0.4 wt. % iodine, having a Mooney value of 40 as | |
| | can prepared according to WO2015/088784 or WO2015/134435 | |
| PFE-2 | Coagulated perfluoropolymer or perfluoropolymer latex obtained | 3M Dyneon |
| | from 24 wt. % solids aqueous latex - 47 wt. % PMVE, 53 wt. % | |
| | TFE having a Mooney value of 60. | |
| PFE-3 | Perfluoroelastomer latex or coagulated gum comprising a copolymer | 3M Dyneon |
| | of 65.8 mol % (52.6 wt. %) TFE, 33 mol % (43.3 wt. %) PMVE, 1.2 | |
| | mol % (3.6 wt. %) of a nitrile vinylether (U.S. Pat. No. 7,019,083) | |
| | with a Mooney value of 60 | |
| PFE-5 | Bromo-containing perfluoroelastomer. Coagulated gum obtained from 34 | 3M Dyneon |
| | wt. % solids aqueous perfluoroelastomer latex - 49 wt. % PMVE, 51 | |
| | wt. % TFE, 0.4 wt. % bromine, having a Mooney value of 90.) | |
| PFE-6 | Coagulated gum or perfluoroelastomer latex obtained from 30 wt. % | 3M Company, St. |
| | solids aqueous perfluoroelastomer latex - 43.8 wt. % PMVE, 52.6 | Paul, MN |
| | wt. % TFE, 1.2 mol % of a nitrile vinylether with a Mooney value of 14 | |
| PFE-7 | Coagulated perfluoropolymer or perfluoropolymer latex obtained from | 3M Dyneon |
| | 27 wt. % solids aqueous latex - 27.2 mol % (37.2 wt %) PMVE, 71.5 | |
| | mol % (58.8 wt %) TFE and 1.3 mol % (4.0 wt. %) of a nitrile | |
| | vinylether; No melting peak was observed. | |

CRYSTALLINE FLUOROPOLYMERS

| | | |
|---|---|---|
| CFP-1 | 15% wt. % aqueous dispersion of copolymer from 87 wt. % | 3M Company |
| | TFE and 13 wt. % HFP; Melt Flow Index at 372° C. and 5 | |
| | kg load = 7 grams/10 minutes; Melting point of 260° C. | |
| CFP-2 | Latex 30 wt. % solids aqueous latex - 96 wt. % TFE, 4 wt. | 3M Dyneon |
| | % PPVE, Tm is 308° C., MFI (372° C./5 kg) 7 g/10 minutes. | |
| CFP-3 | Copolymer of 96 wt. % TFE, 4 wt. % PPVE with a melting point | 3M Company |
| | of 306° C.; Melt Flow Index at 372° C. and 5 kg load = 2 | |
| | grams/10 minutes | |
| CFP-4 | 55 wt. % aqueous dispersion of a copolymer of 87 wt. % TFE, | 3M Company |
| | 13 wt. % HFP stabilized with GENAPOL X089. Melting point | |
| | of 255° C. | |
| CFP-5 | Copolymer from 87 wt. % TFE and 13 wt. % HFP; Melt Flow | 3M Company |
| | Index at 372° C. and 5 kg load = 3 grams/10 minutes; | |
| | Melting point of 260° C. | |
| CFP-6 | Copolymer of 74 wt. % TFE, 20 wt. % ethylene, 2 wt. % HFP | 3M Company |
| | and 4 wt. % PPVE with a melting point of 266° C.; Melt | |
| | Flow Index at 372° C. and 5 kg load = 10 grams/10 minutes | |
| CFP-7 | 30 wt. % aqueous dispersion of TFE homopolymer with a mean | 3M Company |
| | particle size of 195 nanometers. | |
| CFP-8 | 30 wt. % aqueous dispersion of TFE-polymer modified with 900 | 3M Company |
| | ppm PPVE with a mean particle size of 195 nanometers. | |
| CFP-9 | 20 wt. % aqueous dispersion of nitrile-containing copolymer | 3M Dyneon |
| | 95-97 wt. % TFE and PPVE = 3-5% with a melting point of 300° | |
| | C. to 312° C. | |
| CFP-10 | 50 wt. % aqueous stabilized dispersion of a copolymer of 96 | 3M Company |
| | wt. % TFE, 4 wt. % PPVE with a mean particle size of 90 | |
| | nanometers and a melting point of 306° C. | |
| CFP-19 | Coagulated perfluoropolymer or perfluoropolymer latex obtained | 3M Company |
| | from 19 wt. % solids aqueous latex - 97.2 wt % TFE, 1.8 wt % | |
| | perfluorinated allyl ether CF2═CF—CF2—O—C3F7, | |
| | 0.4 wt % PMVE , and 0.6 wt % of a nitrile vinylether; Melting | |
| | point of 310° C.; Melt Flow Index at 372° C. and 5 kg load = | |
| | 57 grams/10 minutes | |
| CFP-20 | Terpolymer of tetrafluoroethylene hexafluoroproylene (TFEHFP) | 3M Dyneon |
| | and VF2; melting point of 208° C. | |

OTHER MATERIALS

| | | |
|---|---|---|
| HFE-7500 | 3-ethoxy perfluorinated 2-methyl hexane obtained under the | 3M Company |
| | trade designation “3M NOVEC 7500” | |
| HFE-7300 | 3-Methoxy perfluorinated 4-methyl pentane obtained under the | 3M Company |
| | trade designation “3M NOVEC 7300” | |
| CQ0282 | Fused silica (D90 = 3 microns; Average = 1-2 microns) | Suzhou Ginet, |
| | | Suzhou, China |
| CQ0382 | Fused silica with surface treatment (D90 = 4 micrometers) | Suzhou Ginet |
| FS-550 | 3M ™ Fused Silica (3.5-5.2 micrometers) | 3M Company |
| QZ1 | Quartz fiber, 3 millimeter length, 8 micrometer diameter | Shenjiu, Zhengzhou, |
| | | China |
| FT9110 | Microglass 9110 (Milled E-glass filaments) | Fibertec Inc., |
| | | Bridgewater, MA |
| BN012 | Boron nitride powder obtained under the trade designation | 3M Company |
| | “BN CFP 012” | |
| MP-1 | Polytetrafluoroethylene (PTFE) micro powder (average particle | 3M Dyneon |
| | size, 8 micrometers); a homopolymer of CF₂═CF₂; obtained under | |
| | the trade designation “3M DYNEON PTFE TF 9205” | |
| MP-2 | Fluoroplastic micro powder, a copolymer of CF2═CF2 & | 3M Dyneon |
| | CF2═CFOCF2CF2CF3 (5 wt %); median particle size | |
| | 8-10 micrometers | |
| BTMSPA | Bis(3-trimethoxysilylpropyl)amine | Gelest Corporation, |
| | | Morrisville, PA |
| 3M release | Silicone-based release liner film | 3M Company |
| liner | | |
| SY Tech Cu | Rz = 1.05 microns | Shengyi Technology |
| | | Co., Ltd., |
| | | Dongguan, China |
| 3M Cu | Rz = 3 microns | 3M Company |

### Test Methods

### Split Post Dielectric Resonator Measurement Test Meth Od (at 25 GHz)

All split-post dielectric resonator measurements were performed in accordance with the standard IEC 61189-2-721 near a frequency of 25 GHz. Each thin material or film was inserted between two fixed dielectric resonators. The resonance frequency and quality factor of the posts are influenced by the presence of the specimen, and this enables the direct computation of complex permittivity (dielectric constant and dielectric loss). The geometry of the split dielectric resonator fixture used in our measurements was designed by the Company QWED in Warsaw Poland. This 25 GHz resonator operates with the TE_{old}mode which has only an azimuthal electric field component so that the electric field remains continuous on the dielectric interfaces. The split post dielectric resonator measures the permittivity component in the plane of the specimen. Loop coupling (critically coupled) was used in each of these dielectric resonator measurements. This 25 GHz Split Post Resonator measurement system was combined with Keysight VNA (Vector Network Analyzer Model PNA 8364C 10 MHz-50 GHz). Computations were performed with the commercial analysis Split Post Resonator Software of QWED to provide a powerful measurement tool for the determination of complex electric permittivity of each specimen at 25 GHz.

### Rheological Studies

The dissolved fluoropolymers were coated into 20 micrometer (um) films on a PET liner. These films were laminated with each other at 110° C. with pressure for several times to prepare 1 mm thick layers. The sample can also be prepared by directly pressing the fluoropolymer solid resins under 110° C./5 megapascals (MPa) for 5 minutes (min) in a 1 mm metal mold using a hot-press machine. 8 mm² samples were punched out from the 1 mm thick samples for rheological experiments. The prepared sample was placed in a rheology analyzer (TA Instruments ARES G2 rheometer) and measurements were performed in parallel plate mode at a frequency of 1 Hz and a strain of 0.1%. The testing temperature was set to increase from 50° C. to 250° C., then cooled down to 50° C. with 6° C./minute ramping rate. The same heating cycle was repeated for two more times without any other set-up changes and data of the heating process was recorded.

### Coefficient of Thermal Expansion (CTE) Measurement Test Method

CTE measurements were conducted using a Thermomechanical Analyzer (TMA) TMA Q400 from TA Instruments (New Castle, DE). The film samples were cut into rectangle shapes (4.5 millimeter (mm)×24 mm, 80-150 microns in thickness) and mounted on the tension clamp. The samples were heated to at least 150° C. using a ramp rate of 3.00° C./minute and then cooled to room temperature at the same rate. Then the samples were heated again to the target temperature. The CTE calculated from the second cycle was reported.

### T-Peel Measurement Test Method

T-peel measurements were conducted using an INSTRON electromechanical universal testing machine using ASTM D1876 standard method for “Peel Resistance of Adhesives,” more commonly known as the “T-peel” test. Peel data was generated using an INSTRON Model 1125 Universal Testing Instrument (Norwood, MA) equipped with a Sintech Tester 20 (MTS Systems Corporation, Eden Prairie, MN). Samples were prepared as follows.

Perfluoropolymer films/sheets or perfluoropolymer/inorganic filler composite films/sheets were obtained by heat-pressing the corresponding coagulated or co-coagulated fluoropolymer or fluoropolymer/inorganic filler powders or gums sandwiched between two PTFE release sheets. The films were pressed at various temperatures (according to the tables below) between heated platens of a Wabash Hydraulic press and then immediately transferred to a cold press. After cooling to room temperature by a “cold pressing”, the resulting sample sheets were peeled off from the PTFE sheets. The resulting films were cut into coupons and subsequently laminated with two Cu foil coupons to obtain sandwich structures (with the perfluoropolymer composite films in the middle). Then the laminated samples were heated at 200-250° C. for 30 minutes between heated platens of a Wabash Hydraulic press and immediately transferred to a cold press. After cooling to room temperature by a “cold pressing”, the resulting sample was subjected to the T-peel measurement test method. The laminated samples were pressed and cut into strips with 1.0-1.5 centimeters (cm) width for T-peel measurement.

Perfluoropolymer coating solutions of Table 5 were individually coated on a copper substrate and the resulting coated substrates were dried at room temperature and then subsequently heated at 80-165° C. for 10-30 minutes. The coated copper samples were either laminated against an uncoated copper coupon or a coated copper coupon for heat lamination for bonding at temperatures (as described in Table 5, below). Then the laminated samples were heated at 200° C. for 30 minutes between heated platens of a Wabash Hydraulic press and immediately transferred to a cold press. After cooling to room temperature by a “cold pressing”, the resulting sample was subjected to the T-peel measurement test method. The laminated samples were pressed and cut into strips with 1 cm width for T-peel measurement.

Perfluoropolymer solutions of Table 6 were coated on a 3M PET release liner (3M Company, St. Paul, MN) and dried at room temperature overnight. The films were then peeled off from the liners and placed into an aluminum tray and heated to dry at 120-165° C. for 20-30 minutes. The resulting films were cut into coupons and subsequently inserted into two Cu foil coupons in a sandwich structure and laminated for bonding at temperatures indicated in the tables for 30 minutes. The laminated samples were heated at 200° C. for 30 minutes between heated platens of a Wabash Hydraulic press and immediately transferred to a cold press. After cooling to room temperature by a “cold pressing”, the resulting sample was subjected to the T-peel measurement test method. The laminated samples were pressed and cut into strips with 1 cm width for T-peel measurement.

### Solubility Test Method

Sample material (10 wt. %, according to Table 8) was coated onto a glass substrate and then dried at 120° C. for 5 minutes. Then the coated glass substrate was subjected to heating for 10 minutes at 150° C., 200° C., or 300° C. individually. The sample was then peeled off of the glass slide and the film was submerged in HFE-7500 and sealed in a glass vial. The glass vial was well sealed with PTFE tape and paraffin film. The vial was then subject to shaking overnight at room temperature to determine if the film dissolved. Solubility results are recorded in Table 8.

### Solvent Extraction Test Method

Sample material (10 wt. %, according to Table 12) was coated onto a glass substrate and then dried at 120° C. for 5 minutes. Then the coated glass substrate was subjected to heating for 10 minutes at 300° C., individually. The sample was then peeled off of the glass slide and the resulting film was weighed. The weighed film was then submerged in excess HFE-7500 and sealed in glass vial. The glass vial was well sealed with PTFE tape and paraffin film. The vial was then subject to shaking overnight at room temperature. The undissolved solid was then removed from the vial, rinsed with HFE-7500, and dried at 120° C. to removed excess solvent. The dried sample was then weighed, and the final weight was compared to the initial weight to determine the percentage of material remaining. Results are recorded in Table 12.

### Differential Scanning Calorimetry (Dsc) Test Method

The specimens were prepared for thermal analysis by weighing and loading the material into Mettler aluminum DSC sample pans. The specimens were analyzed using Mettler Toledo DSC 3+(Columbus, OH) utilizing a heat-cool-heat method in temperature modulated mode (−50 to 350° C. at 10° C./minute). After data collection, the thermal transitions were analyzed using the Mettler STARe Software version 16.00. If present, any glass transitions (Tg) or significant endothermic or exothermic peaks were evaluated based on the second heat flow curve. The glass transition temperatures were evaluated using the step change in the heat flow curve. The onset and midpoint (half height) of the transition were noted at the glass transition. Peak area values and/or peak minimum/maximum temperatures are also determined. Peak integration results are normalized for sample weight and reported in J/g.

A normalized crystallinity of a blend of a crystalline fluoropolymer and an amorphous fluoropolymer can be calculated by the following equation: [delta H of a blend of fluoropolymers/(delta H of the crystalline fluoropolymer (i.e. alone) multiplied by the wt. % of such fluoropolymer in the blend)*100]. An example calculation for the blend of CFP-2/PFE-3 (5:5) is as follows. The normalized crystallinity is [delta H of the blend/(delta H of CFP-2*wt % of CFP-2)*100]. Since the blend contains 50% of CFP-2, the normalized crystallinity is [24.2/(41.6*50%)*100=116].

### Examples

### General Procedure—Amorphous Perfluoropolymer-Crystalline Fluoropolymer Nanoparticle Coagulation or Co-Coagulation Preparation

Perfluoroelastomer PFE-3 (30.5 wt. %), PFE-1 (30.6 wt. %), or PFE-2 (24 wt. %) was either coagulated individually or co-coagulated with CFP latex (30 wt. % CFP-2 latex or 30 wt. % obtained from the dilution of 50 wt. % CFP-10 latex), CFP-9 ((20 wt. %), CFP-4 (55 wt. %), CFP-1 (15 wt. %), CFP-7 (30 wt. %), or CFP-8 (30 wt. %) in the ratios described in the tables below. The latex solutions were mixed and were put on a roller for 20 minutes. Subsequently, the well-mixed solutions were frozen in a fridge overnight. They were taken out and thawed in warm water or in an oven at 60° C. After melting, the precipitates were filtered and washed with deionized water for at least three times. The obtained solids were dried in an air-circulated oven at 55-65° C. overnight to form powders or gums.

### General Procedure—Amorphous Perfluoropolymer-Crystalline Fluoropolymer Nanoparticle Dispersion Coating Solution Preparation

PFE or PFE-CFP were dissolved/dispersed in HFE-7300 by cutting the fluoropolymer materials into small pieces and placing them into separated glass jars and to each of the glass jars was added HFE-7300 solvent. The containers were well sealed with PTFE tape and paraffin film. The solution was subject to vigorous shaking overnight (˜12 hours) to become completely homogenous to obtain a 5-8 wt. % PFE in HFE-7300 solutions (5 g PFE and 95 g HFE-7500) or 10 wt % PFE-CFP in HFE-7300 dispersion solutions.

The above prepared solutions were coated on a 3M release liner or a copper foil substrate with a No. 24 Meyer rod or simply poured the solutions onto the liner to obtain thicker coating samples, and the resulting coatings on copper foil and on release liner Were normally dried at room temperature overnight or cured 120-165° C. for 20-105 minutes. The coated films were released from the release liner and were available for adhesion to copper and Dk/Df measurements (Table 5 & Table 6).

General Procedure—Amorphous Perfluoropolymer-Crystalline Fluoropolymer Nanoparticle Dispersion Coating Solution Preparation when Inorganic Fillers are Present

PFE or PFE-CFP were dissolved/dispersed in HFE-7300 by cutting the fluoropolymer materials into small pieces and placing them into separate glass jars. To each of the glass jars was added HFE-7300 solvent. The containers were well sealed with PTFE tape and paraffin film. The solution was subject to vigorous shaking overnight (approximately 12 hours) to become completely homogenous and obtain a 5-8 wt. % PFE in HFE-7300 solutions (5 g PFE and 95 g HFE-7500), or 10 wt. % PFE-CFP in HFE-7300 dispersion solutions.

In the case of coating solutions containing inorganic fillers, inorganic fillers or mixed fillers were weighed in glass jars separately, to each of the inorganic fillers or mixed fillers was added a small amount of HFE solvent and vortexed for 1-2 minutes. To the HFE-7300 filler or mixed filler slurries were individually added the amounts of the above prepared fluoropolymer IFE solutions and curatives in ratios described in the appropriate table below. The prepared solutions described above were typically stirred under vortex for 1-2 minutes at 2500 revolutions per minute (rpm). The above prepared solutions were coated on clean copper foil substrates with a No. 24 Meyer rod, and the resulting coatings were dried and cured at 150-165° C. for 10-20 minutes. Results are summarized in Table 6.

### General Procedure—Fluoropolymer Film Preparation

The above prepared coagulated or co-coagulated perfluoropolymer powders or gums were also pressed into films/sheets by a heat laminator. Each of the coagulated or co-coagulated fluoropolymer powders or gums was placed between two PTFE release sheets and were heat-pressed according to Tables 2, 3, and 4 based on the melting points of perfluoroplastic resins for 30 minutes between heated platens of a Wabash Hydraulic press and subsequently quenched with a cold press. After cooling to room temperature by a “cold pressing”, the resulting sample was available to use.

The resulting sheets/films were used for Dk/Df, CTE measurements, and for bonding to Cu substrate. Some coagulated co-coagulated polymers or polymer blends may also contain inorganic fillers. They were obtained by coagulating or coagulating polymer latex blends in the presence of inorganic fillers.

In the examples of containing hydrophobic inorganic fillers including boron nitride particles and other hydrophobic fused silica (surface-modified) shown in Table 4, the samples were obtained by mixing latexes or latex blends with alcohol solutions containing hydrophobic particles dispersed alcohol solutions such as isopropanol in desired ratios and by subsequently freezing the coagulation.

### Pfe-3/Cfp Made Via a Melt Process

### Blending CFP-5 and PFE-3 (1:1)

A Haake bowl mixer was electrically heated to 300° C. CFP-5 (35.04 g, in pellet form) was added to the pre-heated mixer and mixed at 20 revolutions per minute (rpm) until uniformly melted (3 minutes). PFE-3 (35.00 g, in crumb form) was added to the mixture and the blend was mixed for a total of 15 minutes. The sample was removed from the bowl mixer and allowed to cool to room temperature.

As pellets of CFP-5 were added to the bowl mixer at 300° C., a notable spike in torque was observed in the mixing bowl as the sample began to melt. The torque built and released over the course of 3 minutes as the sample became uniformly molten. Another spike in torque was observed upon the addition of PFE-3. Interestingly, the final torque measured of the molten CFP-5/PFE-3 mixture was significantly higher than observed with the molten CFP-5.

### Blending CFP-3 and PFE-3 (1:1)

A Haake bowl mixer was electrically heated to 330° C. CFP-3 (35.00 g, in pellet form) was added to the pre-heated mixer and mixed at 20 rpm until uniformly melted (3 minutes). PFE-3 (35.01 g, in crumb form) was added to the mixture and the blend was mixed for a total of 15 minutes. The sample was removed from the bowl mixer and allowed to cool to room temperature.

As CFP-3 was added to the bowl mixer at 330° C., a notable spike in torque was observed in the mixing bowl as the sample began to melt. The torque built and released over the course of 3 minutes as the pellets of CFP-3 melted and softened. Unlike the CFP-5 example, the pellets of CFP-3 did not flow to form a homogenous mixture under these conditions. Another spike in torque was observed upon the addition of PFE-3. Interestingly, the final torque measured of the molten CFP-3/PFE-3mixture was significantly higher than observed with the molten CFP-3, akin to the CFP-5/PFE-3 example. In stark contrast to the CFP-5/PFE-3 blend, the measured torque of the CFP-3/PFE-3 mixture continued to rise as the sample was heated.

TABLE 2
Adhesion strength between Cu substrate and perfluoropolymer adhesive films

| | | | Cu Bonding Substrate/ | | |
|---|---|---|---|---|---|
| | | | Lamination Temperature, | Cu Peel | Df at |
| EXAMPLE | Film Formulation | PPVE or PMVE, mol % (wt. %) | ° C.* | force, N/cm | 25 GHz |
| Control EX-1 | CFP-2 | PPVE, 1.5-2.0 mol % (4 wt. %) | 3M Cu/310° C. | 1.4 | 0.0004 |
| Control EX-2 | CFP-2 | PPVE, 1.5-2.0 mol % (4 wt. %) | 3M Cu/300° C. | 0.8 | 0.0004 |
| Control EX-3 | CFP-2 | PPVE, 1.5-2.0 mol % (4 wt. %) | 3M Cu/250° C. | no bonding | 0.0004 |
| Control EX-4 | CFP-1 | | 3M Cu/250° C. | 1.5 | 0.0004 |
| Control EX-5 | CFP-1 | | 3M Cu/266° C. | 4.2 | 0.0004 |
| Control EX-6 | CFP-1 | | 3M Cu/300° C. | 1.9 | 0.0004 |
| EX-7** | CFP-2/PFE-2 (1:1) (film pressed at 300° C.) | | 3M Cu/200° C. | 7.8 | 0.0011 |
| EX-8 | CFP-2/PFE-2 (3:7) (film pressed at 300° C.) | | 3M Cu/200° C. | 6.0 | 0.0013 |
| EX-9 | CFP-2/PFE-2 (3:7) (film pressed at 300° C.) | | SY Tech Cu/200° C. | 6.8 | 0.0013 |

*All samples were laminated at the listed temperature for 3 minutes.
**EX = Examples

TABLE 3
Adhesion strength between Cu substrate and perfluoropolymer adhesive films

| | | Bonding Substrate/ | Peel | Df at |
|---|---|---|---|---|
| EXAMPLE | Film Formulation | Lamination Conditions | force, N/cm* | 25 GHz |
| EX-10 | PFE-1/CFP-4 (7:3) (film pressed at 280° C.) | 3M Cu/200° C. for 25 min | 8.4 | 0.0018 |
| EX-11 | PFE-1/CFP-2 (7:3) (film pressed at 310° C.) | 3M Cu/200° C. for 25 min | 26.6 | |
| EX-12 | PFE-6 (Mooney = 13)/CFP-2 (30%) (7:3) (film pressed at 300-310° C.) | 3M Cu/200° C. for 20 min | 11.9 | |
| EX-13 | PFE-3/CFP-2 (5:5) (film pressed at 300-310° C.) | 3M Cu/200° C. for 30 min | 17.1 | |
| EX-14 | PFE-3/CFP-2 (7:3) (film pressed at 300-310° C.) | 3M Cu/200° C. For 30 min | 16.7 | 0.0013 |
| EX-15 | PFE-3/CFP-2 (30%) (5:5) (film pressed at 300-310° C.) | 3M Cu/200° C. for 25 min | 10.7 | 0.0011 |
| EX-16 | PFE-3/CFP-2 (30%) (3:7) (film pressed at 300-310° C.) | 3M Cu/300° C. for 20 min | 6.9 | 0.0009 |
| EX-17 | PFE-3/CFP-9 (5:5) (film pressed at 300-310° C.) | 3M Cu/250° C. for 30 min | 12.4 | 0.0012 |
| EX-18 | PFE-3/CFP-9 (7:3) (film pressed at 300-310° C.) | 3M Cu/250° C. for 30 min | 13.0 | 0.0014 |
| EX-19 | PFE-3/CFP-6 (8:2) (film pressed at 250° C.) | 3M Cu/250° C. for 30 min | 6.8 | 0.0034 |
| EX-20 | PFE-7 (37.2 wt. %% PMVE)/CFP-2 (7:3) (film pressed at 300° C.) | 3M Cu/250° C. for 20 min | 13.7 | |
| EX-21 | PFE-7 (37.2 wt. % PMVE)/CFP-9 (7:3) (film pressed at 300° C.) | 3M Cu/200° C. for 25 min | 12.6 | |
| EX-22 | PFE-7 (37.2 wt. % PMVE)/CFP-2 (5:5) (film pressed at 310° C.) | 3M Cu/200° C. for 30 min | 11.1 | |
| EX-23 | PFE-7 (37.2 wt. % PMVE)/CFP-2 (7:3) (film pressed at 310° C.) | 3M Cu/200° C. for 30 min | 9.9 | |

*= average of 3 samples.

TABLE 4
Cu-bondable perfluoropolymer composite films

| | | Bonding Substrate/ | Peel | Df at |
|---|---|---|---|---|
| EXAMPLE | Formulation | Lamination Conditions | force, N/cm | 25 GHz |
| EX-24 | PFE-3/CFP-2/FT9110 [(7:3 PFE/CFP) (5:2 PFE/CFP to | 3M Cu/200° C. for 35 min | 26.8 | 0.0028 |
| | FT9110)]; film pressed at 310° C. | | | |
| EX-25 | PFE-3/CFP-2/FT9110 [(7:3 PFE/CFP) (5:2 PFE/CFP to | Sy Tech Cu/200° C. for 35 min | 10.3, copper | 0.0028 |
| | FT9110)]; film pressed at 310° C. | | tore | |
| EX-26 | PFE-3/CFP-2/FS-550 [(7:3 PFE/CFP) (3:1 PFE/CFP to | 3M Cu/200° C. for 1 hour | 11.6 | 0.0018 |
| | FS-550)]; film pressed at 310° C. | | | |

*= average of 3 samples.

TABLE 5
Perfluoropolymer coating formulations bonded to copper substrate

| | | Sample Lamination | Adhesion | Df at |
|---|---|---|---|---|
| EXAMPLE | Coating Formulation on Cu for Lamination | Conditions | to Cu, N/cm | 25 GHz |
| Control EX-27 | CFP-2 film | 310° C. | <2 | 0.0006 |
| EX-28 | Coated 10% PFE-3/CFP-2 (9:1) on Cu | 200° C. | 20.1 | 0.0018 |
| EX-29 | Coated 10% PFE-3/CFP-10 (7:3) on Cu | 200° C. | 21.2 | 0.0015 |
| EX-30 | Coated 10% PFE-3/CFP-10 (7:3) on Cu | 310° C. | 22.1 | 0.0015 |
| EX-31 | Coated 10% PFE-3/CFP-2 (7:3) on Cu | 200° C. | 26.1 | 0.0013 |
| EX-32 | Coated 10% PFE-1/CFP-2 (9:1) on Cu | 200° C. | 18.7 | 0.0018 |
| EX-33 | Coated 10% PFE-3/CFP-2 (7:3) on Cu | 310° C. | 26.4 | 0.0013 |
| EX-34 | Coated 10% PFE-3/CFP-1 (7:3) on Cu | 200° C., 60 min. | 23.2 | |
| EX-35 | Coated PFE-6 (Mooney = 13)/CFP-2 (7:3) on Cu | 200° C. | 13.0 | |

TABLE 6
Cu-Bondable Perfluorinated Polymer Films Obtained by Coating

| | | Sample | Cu Peel | | CTE, 2^{nd} |
|---|---|---|---|---|---|
| | | Lamination | force, | Dk/Df at | Heat, μm/ |
| EXAMPLE | Formulation | Conditions | N/cm | 25 GHz | (m · ° C.) |
| Control EX-36 | CFP-2 film | 310° C. | <2 | 0.0006 (Df) | |
| EX-37 | 10 wt. % PFE-3/CFP-2 (7:3) coated on a release liner & dried @ 125° C. | 200° C. | 31.8 | 2.18/0.0013 | 218 |
| EX-38 | 10 wt. % PFE-3/CFP-9 (7:3) coated on a release liner & dried at room temp. | 200° C. | 29.3 (13.6) | 2.13/0.0014 | |
| EX-39 | 10 wt. % PFE-3/CFP-9 (5:5) coated on a release liner & dried at room temp. | 200° C. | 12.5 | 2.11/0.0012 | 249 |
| EX-40 | 10 wt. % PFE-3/CFP-8 (7:3) coated on a release liner & dried at room temp. | 200° C. | 11.6 | | |
| EX-41 | PFE-1/CFP-2 (7:3) BN012/CQ0382/Q Z1 [75:10:10:5] coated on a release | | | 2.13/0.00054 | |
| | liner and dried at 165° C. | | | | |
| EX-42 | PFE-1/CFP-2 (7:3) BN012/CQ0382 [8:1:1] coated on a release liner and | | | 2.34/0.00065 | |
| | dried at 165° C. | | | | |
| EX-43 | PFE-3/MP-1/FS-550 (40/48/12) coated on a release liner and dried at 165° C. | 200° C. | 11.2 | 1.95/0.0008 | |
| EX-44 | PFE-3/MP-2/FS-550 (40/48/12) coated on a release liner and dried at 165° C. | 200° C. | 10.4 | 1.96/0.0009 | |

Perfluoropolymer solutions were coated on a release liner and dried at room temperature overnight or cured at 120-165° C. for 30-105 minutes. The resulting films with an average 15-40 micrometer thickness were released from the liner and subsequently laminated against Cu foil in a sandwich structure for bonding at temperatures indicated in the tables and under 1-2 tons of pressure for 30 minutes.

TABLE 7
Adhesion strength between Cu substrate and perfluoropolymer
blend adhesive films obtained by a melt compounding process

| | | Sample | | |
|---|---|---|---|---|
| | | Lamination | Peel force, | Dk/Df at |
| EXAMPLE | Formulation | Conditions | N/cm* | 25 GHz |
| EX-45 | PFE-3/CFP-5 | Bonded to 3M Cu | 9.9 | 2.03/ |
| | (1:1) | at 250° C. for | | 0.00092 |
| | | 30 min | | |
| EX-46 | PFE-3/CFP-3 | Bonded to Cu | 4.4 | 2.02/ |
| | (1:1) | at 250° C. for | | 0.00088 |
| | | 30 min | | |

*= average of 3 samples.

TABLE 8
Dispersed fluoroplastic nanoparticles crosslink PFE via co-crystallization upon heating

| EXAMPLE | Material | 150° C. for 10 minutes | 200° C. for 10 minutes | 300° C. for 10 minutes |
|---|---|---|---|---|
| Control EX-47 | PFE-3 | Soluble in HFE-7500 | Soluble in HFE-7500 | Soluble in HFE-7500 |
| EX-48 | PFE-3/CFP-2 (7:3) | Partially soluble in HFE-7500 | Not soluble in HFE-7500 | Not soluble in HFE-7500 |
| EX-49 | PFE-3/CFP-7 (7:3) | Partially soluble in HFE-7500 | Not soluble in HFE-7500 | Not soluble in HFE-7500 |
| EX-50 | PFE-3/CFP-20 (7:3) | Partially soluble in HFE-7500 | Not soluble in HFE-7500 | Not soluble in HFE-7500 |

It was observed that PFE-3 used for dispersing fluoroplastic nanoparticles into perfluorinated or HFE solvents remained non-crosslinked and soluble in perfluorinated or HFE solvents even after heated at 300° C. In the contrast, PFE-3 in the presence of dispersed fluoroplastic nanoparticles became crosslinked and insoluble in solvents after coating and drying at merely about 150° C. This is believed to be a result of co-crystallization upon heating. The usefulness derives from the ability to coat or extrude temperature sensitive materials with insoluble fluoropolymers.

The DSC data shown in the Tables 9 and 10, below, demonstrates that the delta H decrease corresponds to the increase of crystallinity. Thus, the presence of PFE-3 or PFE-2 fluoropolymer in the CFP plastic obtained by a co-coagulation contributes to the total crystallinity increase compared with that of the CFP comparative example. In contrast, Table 11 shows the decreased crystallinity when simply mixing the resin and elastomer together. This strongly suggests that samples obtained from co-coagulation of nanosized CFP and PFE latexes demonstrate a much higher tendency to interact with each other physically than samples obtained through the simple mixing of the resin and rubber when subjected to heat.

TABLE 9
DSC data with PFE-3

| | | Delta H, J/g | Normalized |
|---|---|---|---|
| EXAMPLE | Formulation | (second heat) | Crystallinity |
| EX-51 | CFP-2/PFE-3 (5:5) | 24.2 | 116 |
| EX-52 | CFP-2/PFE-3 (6:4) | 27.0 | 108 |
| EX-53 | CFP-2/PFE-3 (7:3) | 30.6 | 105 |
| CE-54 | CFP-2 | 41.6 | 100 |

* Tested samples in the table were obtained via co-coagulation.

TABLE 10
DSC data with PFE-2 with samples obtained via co-coagulation

| | | Delta H, J/g | Normalized |
|---|---|---|---|
| EXAMPLE | Formulation | (second heat) | Crystallinity |
| EX-55* | CFP-2/PFE-2 (3:7) | 14.1 | 116 |
| EX-56* | CFP-2/PFE-2 (5:5) | 21.6 | 107 |
| EX-57** | CFP-2/PFE-2 (3:7) | 18.0 | 148 |
| EX-58** | CFP-2/PFE-2 (5:5) | 32.4 | 160 |
| Control EX-59 | CFP-2 | 40.5 | 100 |

*Examples were hot-pressed at 188° C.
**Examples were hot-pressed at 330° C.

TABLE 11
DSC data on examples with simple mixing the fluoroelastomer
gum and the crystalline fluoropolymer resin

| | | Delta H, J/g | Normalized |
|---|---|---|---|
| EXAMPLE | Formulation | (second heat) | Crystallinity |
| EX-60 | CFP-2/PFE-3 (1:1) | 15.4 | 76 |
| | mixed at 330° C. | | |
| Control EX-61 | CFP-2 | 40.5 | 100 |

PFE-3 solvent extraction experiments were also carried out as shown in Table 12, below. The results showed a significant amount of PFE remained in insoluble samples. The fact that the large amount of PFE remained in the insoluble solid samples strongly suggests PFE co-crystallization with CFP. If PFE did not undergo co-crystallization with perfluoroplastic CFP, it would be anticipated that all of the PFE-3 would be readily soluble in HFE and could have been extracted out by the solvent.

TABLE 12
Solvent extraction experiments

| | | 300° C. for 10 minutes in HFE-7500 | | |
|---|---|---|---|---|
| | | Solid yield | Solid yield | |
| | | after first | after second | Final ratio |
| | | HFE | HFE | of PFE to |
| EXAMPLE | Formulation | extraction | extraction | fluoroplastic |
| Control | PFE-3 | Soluble | Soluble | N/A |
| EX-62 | | | | |
| EX-63 | PFE-3/CFP-20 | 51.04 wt. % | 94.03 wt. % | 1:2.3 |
| | (7:3) | (precipitate) | (precipitate) | |
| EX-64 | PFE-3/CFP-7 | 70.01 wt. % | 95.57 wt. % | 1:1 |
| | (7:3) | (precipitate) | (precipitate) | |
| EX-65 | PFE-3/CFP-2 | 63.03 wt. % | 98.66 wt. % | 1:1.2 |
| | (7:3) | (precipitate) | (precipitate) | |

TABLE 13
Rheological experiments - storage modulus

| | | Storage Modulus, MPa | | |
|---|---|---|---|---|
| | | First Cycle | | |
| | | | | Difference |
| | | | | between 190° |
| EXAMPLE | Formulation | 150° C. | 190° C. | C. and 150° C. |
| EX-66 | PFE-3/CFP-2 | 0.18 | 0.41 (2.27 | 0.23 |
| | (7:3) | | greater) | |
| EX-67 | PFE-3/CFP-2 | 0.30 | 0.63 (2.1 | 0.33 |
| | (7:3) + 0.25% | | greater) | |
| | BTMSPA | | | |
| EX-68 | PFE-3/CFP-2 | 0.36 | 0.24 | −0.12 |
| | (7:3) + 0.5% | | | |
| | BTMSPA | | | |
| EX-69 | PFE-3/CFP-2 | 0.79 | 0.48 | −0.31 |
| | (7:3) + 1.0% | | | |
| | BTMSPA | | | |
| EX-70 | PFE-3/CFP-2 | 0.97 | 1.02 | 0.05 |
| | (7:3) + 1.8% | | | |
| | BTMSPA | | | |

TABLE 14
Rheological experiments - Tan δ

| | | Tan δ at 150° C. | |
|---|---|---|---|
| | | First | Second |
| EXAMPLE | Formulation | Cycle | Cycle |
| EX-71 | PFE-3/CFP-2 (7:3) | 0.75 | 0.21 |
| EX-72 | PFE-3/CFP-2 (7:3) + 0.25% BTMSPA | 0.58 | 0.14 |
| EX-73 | PFE-3/CFP-2 (7:3) + 0.5% BTMSPA | 0.52 | 0.29 |
| EX-74 | PFE-3/CFP-2 (7:3) + 1.0% BTMSPA | 0.28 | 0.19 |
| EX-75 | PFE-3/CFP-2 (7:3) + 1.8% BTMSPA | 0.13 | 0.11 |

### Standard Solution and Film Preparation Procedure for Perfluoroelastomer-Perfluoroallylether Coatings and Films

For Tables 15 and 16, perfluoropolymers containing CFP-19 were co-coagulated. Solutions containing co-coagulated perfluoropolymers are referred to as resins and may contain one or more inorganic or organic fillers (e.g., silica nanoparticles, quartz fibers, or PTFE particles) dissolved in HFE-7300. Solutions were prepared as follows.

Dry components such as the fillers and resins were combined in a container in weight ratios described in the tables below and then the solvent was added to make solution concentrations at 15-30 wt. %. The container was sealed and shaken vigorously for 30 seconds to a minute to mix the contents well. The container was then placed on a roller to gently agitate and mix the contents for a minimum of 18 hours. The solution was checked after ˜18 hours for lumps or dry sections adhered to the glass. If the solution was determined to be completely mixed and ready for coating, it was removed from the rollers; if the solution appeared to require further mixing, it is left on the roller for an additional 12 to 24 hours.

The solution was then coated on a release liner using a Gardco wet film applicator set to a 15-20 mil (0.4-0.5 millimeter) gap. Gap size was adjusted based on solution viscosity and desired film thickness. The film was covered with a shallow pan and allowed to dry at room temperature for 4 to 12 hours. The film was then dried in a forced air oven at 165° C. for 30-60 minutes to ensure the complete removal of solvent. The film thickness was in a range of 20-150 microns based on the thickness requirements for Dk/Df measurements at different frequencies. The resulting films were cut into coupons and subsequently inserted into two Cu foil coupons in a sandwich structure and laminated for bonding at temperatures indicated in the tables below for 30 minutes. The laminated samples were then heated at 200° C. for 30 minutes between heated platens of a Wabash Hydraulic press and immediately transferred to a cold press. After cooling to room temperature by a “cold pressing”, the resulting sample was subjected to the T-peel measurement test method. The laminated samples were pressed and cut into strips with 1 cm width for T-peel measurement.

For Tables 17 and 18, perfluoropolymer films/sheetswere obtained by heat-pressing the corresponding coagulated or co-coagulated fluoropolymer or fluoropolymer/inorganic filler powders or gums placed in between two PTFE release sheets and pressed at 300° C. (according to the tables below) between heated platens of a Wabash Hydraulic press and immediately transferred to a cold press. After cooling to room temperature by a “cold pressing”, the resulting films were peeled off from the PTFE release sheets to make them available for bonding lamination. The resulting films were cut into coupons and subsequently laminated with two Cu foil coupons to obtain sandwich structures (with the perfluoropolymer composite films in the middle). Then the laminated samples were heated at 200-250° C. (according to the table) for 30 minutes between heated platens of a Wabash Hydraulic press and immediately transferred to a cold press. After cooling to room temperature by a “cold pressing”, the resulting sample was subjected to the T-peel measurement test method. The laminated samples were pressed and cut into strips with 1.0-1.5 centimeters (cm) width for T-peel measurement.

TABLE 15
Perfluoropolymer coating formulations laminated to
copper substrate at 200° C.

| | | | Ratio of | Avg Cu | | |
|---|---|---|---|---|---|---|
| | | | resin | bonding, | | |
| EXAMPLE | Resin | Filler | to filler | N/cm | Dk | Df |
| EX-76 | PFE-3/ | N/A | N/A | 10.1 | 2.06 | 0.00129 |
| | CFP-19 | | | | | |
| | (7:3) | | | | | |
| EX-77 | PFE-3/ | N/A | N/A | 10.2 | | |
| | CFP-19 | | | | | |
| | (6:4) | | | | | |
| EX-78 | PFE-3/ | CQ0382 | 80:20 | 9.6 | 2.10 | 0.00103 |
| | CFP-19 | | | | | |
| | (6:4) | | | | | |
| EX-79 | PFE-3/ | CQ0382 | 70:30 | 8.7 | 2.01 | 0.00100 |
| | CFP-19 | | | | | |
| | (6:4) | | | | | |
| EX-80 | PFE-3/ | CQ0382 | 60:40 | 6.2 | 2.39 | 0.00092 |
| | CFP-19 | | | | | |
| | (6:4) | | | | | |
| EX-81 | PFE-3/ | CQ0282 | 80:20 | 9.5 | 2.32 | 0.00112 |
| | CFP-19 | | | | | |
| | (7:3) | | | | | |
| EX-82 | PFE-3/ | CQ0282 | 80:20 | 10.2 | 2.23 | 0.00115 |
| | CFP-19 | | | | | |
| | (6:4) | | | | | |

TABLE 16
Perfluoropolymer coating formulations laminated to
copper substrate at 200° C.

| | | | Ratio of | Avg Cu | Bond | | |
|---|---|---|---|---|---|---|---|
| EXAM- | | | resin | bonding, | Temp, | | |
| PLE | Resin | Filler | to filler | N/cm | ° C. | Dk | Df |
| EX- | PFE-1/ | N/A | N/A | 7.3 | 200 | 2.05 | 0.00078 |
| 83 | CFP-19 | | | | | | |
| | (7:3) | | | | | | |
| EX- | PFE-1/ | CQ0382 | 80:20 | 7.4 | 200 | 2.30 | 0.00076 |
| 84 | CFP-19 | | | | | | |
| | (7:3) | | | | | | |
| EX- | PFE-1/ | CQ0282 | 90:10 | 9.3 | 200 | 2.20 | 0.0007 |
| 85 | CFP-19 | | | | | | |
| | (7:3) | | | | | | |
| EX- | PFE-1/ | CQ0282 | 80:20 | 7.8 | 200 | 2.16 | 0.00069 |
| 86 | CFP-19 | | | | | | |
| | (7:3) | | | | | | |
| EX- | PFE-1/ | CQ0282 | 90:10 | 9.1 | 200 | 2.22 | 0.00075 |
| 87 | CFP-19 | | | | | | |
| | (6:4) | | | | | | |
| EX- | PFE-1/ | CQ0282 | 80:20 | 8.4 | 200 | 2.23 | 0.00071 |
| 88 | CFP-19 | | | | | | |
| | (6:4) | | | | | | |
| EX- | PFE-1/ | N/A | N/A | 5.5 | 200 | 2.02 | 0.00080 |
| 89 | CFP-19 | | | | | | |
| | (1:1) | | | | | | |
| EX- | PFE-1/ | CQ0382 | 80:20 | 4.6 | 200 | 2.35 | 0.00087 |
| 90 | CFP-19 | | | | | | |
| | (1:1) | | | | | | |
| EX- | PFE-1/ | N/A | N/A | 8.6 | 200 | 2.04 | 0.00068 |
| 91 | CFP-4 | | | | | | |
| | (7:3) | | | | | | |
| EX- | PFE-1/ | CQ0282 | 90:10 | 8.8 | 200 | | |
| 92 | CFP-4 | | | | | | |
| | (7:3) | | | | | | |
| EX- | PFE-1/ | N/A | N/A | 5.1 | 200 | 2.05 | 0.00066 |
| 93 | CFP-4 | | | | | | |
| | (1:1) | | | | | | |

TABLE 17
Perfluoropolymer adhesive sheets obtained by pressing powder at 310°
C., laminated on copper substrate at 200° C.

| | | Avg Cu | Bond | | |
|---|---|---|---|---|---|
| | | bonding, | Temp, | | |
| EXAMPLE | Resin | N/cm | ° C. | Dk | Df |
| EX-94 | PFE-1/CFP-19 (7:3) | 11.0 | 200 | 2.06 | 0.00098 |
| EX-95 | PFE-1/CFP-19 (6:4) | 15.0 | 200 | 1.99 | 0.00074 |
| EX-96 | PFE-1/CFP-19 (6:4) | 10.9 | 250 | 1.99 | 0.00074 |

TABLE 18
Perfluoropolymer adhesive sheets obtained by pressing powder at 310°
C., laminated on copper substrate at 200° C.

| | | Cu bonding | Average Cu | | |
|---|---|---|---|---|---|
| EXAMPLE | Formulation | conditions | bonding, N/cm | Dk | Df |
| EX-97 | PFE-2/CFP-2 (7:3) | 200° C. 30 min | 9.2 | 2.07 | 0.00160 |
| EX-98 | PFE-2/CFP-2 (6:4) | 200° C. 30 min | 7.1 | 2.02 | 0.00136 |
| EX-99 | PFE-2/CFP-19 (6:4) | 200° C. 30 min | 7.1 | 2.05 | |
| EX-100 | PFE-2/CFP-19 (1:1) | 200° C. 30 min | 6.8 | 2.06 | 0.00132 |
| EX-101 | PFE-5/CFP-19 (6:4) | 200° C. 30 min | 13.1 | 2.05 | 0.00123 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. An electronic telecommunication article comprising a layer of fluoropolymer composition comprising:
an amorphous fluoropolymer comprising at least 80, 85, or 90% by weight of polymerized units perfluorinated monomers including one or more unsaturated perfluorinated alkyl ethers; and crystalline fluoropolymer;
wherein the fluoropolymer composition lacks crosslinks of a chemical curing agent.

2. The electronic telecommunication article of claim 1 wherein the fluoropolymer composition is a substrate, patterned layer, insulating layer, passivation layer, cladding, protective layer, or a combination thereof.

3. The electronic telecommunication article of claim 1 wherein the article is an integrated circuit, printed circuit board, antenna or optical cable.

4-6. (canceled)

7. The electronic telecommunication article of claim 1 wherein the fluoropolymer composition has
i) a dielectric constant (Dk) of less than 2.75, 2.70, 2.65, 2.60, 2.55, 2.50, 2.45, 2.40, 2.35, 2.30, 2.25, 2.20, 2.15, 2.10, 2.05, 2.00, or 1.95;
ii) a dielectric loss of less than 0.01, 0.009, 0.008, 0.007, 0.006, 0.005, 0.004, 0.003, 0.002, 0.001, 0.0009, 0.0008, 0.0007, or 0.0006;
or a combination thereof.

8. The electronic telecommunication article of claim 1 wherein the amorphous fluoropolymer comprises 40 to 60% by weight of polymerized units of TFE based on the total weight of the fluoropolymer.

9. The electronic telecommunication article of claim 1 wherein the unsaturated perfluorinated alkyl ether of the fluoropolymer has the general formula
R_{f}—O—(CF₂)ₙ—CF═CF₂
wherein n is 1 or 0 and R_{f} is a perfluoroalkyl or perfluoroether group.

10. The electronic telecommunication article of claim 1 wherein the fluoropolymer composition comprises polymerized unit of HFP.

11. The electronic telecommunication article of claim 1 wherein the fluoropolymer composition comprises no greater than 5, 4, 3, 2, 1 or 0.1 wt.-% of polymerized units derived from non-fluorinated or partially fluorinated monomers and/or comprises no greater than 5, 4, 3, 2, 1 or 0.1 wt. % of ester-containing linkages.

12. The electronic telecommunication article of claim 1 wherein the crystalline fluoropolymer is insoluble in fluorinated solvent.

13. The electronic telecommunication article of claim 1 wherein crystalline fluoropolymer comprises a greater amount of polymerized units of TFE than the amorphous fluoropolymer.

14. The electronic telecommunication article of claim 1 wherein the crystalline fluoropolymer comprises submicron particles and/or comprises particles having a particle size greater than 1 micron.

15. (canceled)

16. The electronic telecommunication article of claim 14 wherein the crystalline fluoropolymer particles are sintered or co-sintered with amorphous fluoropolymer particles.

17. The electronic telecommunication article of claim 1 wherein the fluoropolymer composition comprises 10 to 80 wt. % of crystalline fluoropolymer.

18. The electronic telecommunication article of claim 1 wherein the fluoropolymer composition has a normalized crystallinity of less than 100%.

19. The electronic telecommunication article of claim 1 wherein the fluoropolymer composition has a normalized crystallinity of greater than 100%.

20. The electronic telecommunication article of claim 1 wherein the fluoropolymer composition has a higher first cycle tan delta for a temperature in a range from 100° C. to a temperature less than the melt temperature of the fluoropolymer composition than the same fluoropolymer composition further comprising crosslinks of a chemical curing agent.

21. The electronic telecommunication article of claim 1 wherein the fluoropolymer composition has a lower first cycle storage modulus for a temperature in a range from 100° C. to a temperature less than the melt temperature of the fluoropolymer composition than the same fluoropolymer composition further comprising crosslinks of a chemical curing agent.

22. The electronic telecommunication article of claim 1 wherein the fluoropolymer composition has an irreversible storage modulus increase between the first cycle and second cycle at a temperature in a range from 100° C. to a temperature less than the melt temperature of the fluoropolymer composition.

23. The electronic telecommunication article of claim 1 wherein the fluoropolymer composition is insoluble in fluorinated solvent selected from a partially.

24. (canceled)

25. The electronic telecommunication article of claim 1 wherein the amorphous and/or crystalline fluoropolymer further comprises cure sites selected from nitrile, iodine, bromine, chlorine, and amidine.

26-50. (canceled)
